(19) United States
(12) Patent Application Publication
(10) Pub. No.: US 2026/0064754 A1
(43) Pub. Date: Mar. 5, 2026

(54) SYSTEM AND METHOD FOR PROVIDING AGGREGATED SUMMARIES AND ASPECT SCORES FOR LARGE UNSTRUCTURED TEXTUAL DATA

(71) Applicant: ORACLE INTERNATIONAL CORPORATION, Redwood Shores, CA (US)

(72) Inventors: Rutuja Joshi, Redwood City, CA (US); Gabrielle Prichard, Austin, TX (US); Sudhanshu Kandala, Hyderabad (IN); Albert Gevorgyan, Cambridge (GB)

(21) Appl. No.: 19/300,292

(22) Filed: Aug. 14, 2025

Related U.S. Application Data
(60) Provisional application No. 63/690,579, filed on Sep. 4, 2024.

(51) Int. Cl. G06F 16/34

(52) U.S. Cl. CPC G06F 16/345

(57) ABSTRACT

Embodiments described herein are generally related to data analytics environments, and to systems and methods for providing aggregated summaries and aspect scores associated with unstructured textual data. In accordance with an embodiment, the system uses a key-based or batch approach that assesses factors associated with an unstructured textual dataset, such as, for example, a total number of text entries per key, or the character length of each text entry. Based on a consideration of such factors, the system sends batches of text entries, and a prompt, to a large language model processor, to collect intermediate batch results. The intermediate batch results can be used first to develop a numerical score or summary for each key, directed to various aspects of interest within the data; and subsequently to generate aggregated summaries and/or aspect scores associated with the textual dataset, for use in displaying visualizations or returning additional analytical information.

### Claim of Priority and Cross-reference to Related Applications:

This application claims the benefit of priority to U.S. Provisional Patent Application titled “SYSTEM AND METHOD FOR PROVIDING AGGREGATED SUMMARIES AND ASPECT SCORES FOR LARGE UNSTRUCTURED TEXTUAL DATA”, Application No. 63/690,579, filed Sep. 4, 2024; which above application and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics environments, and are particularly directed to systems and methods for providing aggregated summaries and aspect scores associated with unstructured textual data.

### BACKGROUND

Generally described, data analytics systems and methods enable the computer-based examination of an amount of data, to derive an analytic data, metrics, conclusions, or other types of analytical information from, or descriptive of, the source data.

Such data analytics environments can be used, for example, to generate an analytic business intelligence data, such as a set of data metrics or measures operating as key performance indicators, which analytically describe an organization's business-related data in a format useful to its decision-makers.

Increasingly, various data analytics environments have adopted the use of large language models in their analytics offerings, for example with regard to parsing a user-provided input or a reference text.

However, typical approaches to using large language models are less successful at interpreting context, or extracting quantifiable metrics with justification. For example, such approaches generally lack the sophistication required for semantic searching, and may not consider nuanced concepts or sentiments within an input or reference text. The limitations associated with such approaches become increasingly evident when attempting to aggregate or summarize large amounts of unstructured textual data.

### SUMMARY

Embodiments described herein are generally related to data analytics environments, and to systems and methods for providing aggregated summaries and aspect scores associated with unstructured textual data.

In accordance with an embodiment, the system uses a key-based or batch approach that assesses factors associated with an unstructured textual dataset, such as, for example, a total number of text entries per key, or the character length of each text entry.

Based on a consideration of such factors, the system sends batches of text entries, and a prompt, to a large language model processor, to collect intermediate batch results. The intermediate batch results can be used first to develop a numerical score or summary for each key, directed to various aspects of interest within the data; and subsequently to generate aggregated summaries and/or aspect scores associated with the textual dataset, for use in displaying visualizations or returning additional analytical information.

### BRIEF DESCRIPTION OF THE DRAWINGS

FIG. 1 illustrates a system for providing a cloud infrastructure or data analytics environment, in accordance with an embodiment.

FIG. 2 further illustrates a system for providing a cloud infrastructure or data analytics environment, in accordance with an embodiment.

FIG. 3 illustrates an example use of the system to provide a data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 further illustrates an example data analytics environment, in accordance with an embodiment.

FIG. 9 further illustrates an example data analytics environment, including the use of a large language model, in accordance with an embodiment.

FIG. 10 further illustrates an example data analytics environment, including the use of retrieval-augmented generation, in accordance with an embodiment.

FIG. 11 illustrates a system for providing aggregated summaries and aspect scores associated with unstructured textual data, in accordance with an embodiment.

FIG. 12 further illustrates a system for providing aggregated summaries and aspect scores associated with unstructured textual data, in accordance with an embodiment.

FIG. 13 further illustrates a system for providing aggregated summaries and aspect scores associated with unstructured textual data, in accordance with an embodiment.

FIG. 14 further illustrates a system for providing aggregated summaries and aspect scores associated with unstructured textual data, in accordance with an embodiment.

FIG. 15 further illustrates a system for providing aggregated summaries and aspect scores associated with unstructured textual data, in accordance with an embodiment.

FIG. 16 further illustrates a system for providing aggregated summaries and aspect scores associated with unstructured textual data, in accordance with an embodiment.

FIG. 17 illustrates a method for providing aggregated summaries and aspect scores associated with unstructured textual data, in accordance with an embodiment.

FIG. 18 illustrates an example use of the system in combination with a data flow, in accordance with an embodiment.

FIG. 19 illustrates an example use of the system to provide aggregated summaries and aspect scores for unstructured textual data, in accordance with an embodiment.

FIG. 20 further illustrates an example use of the system to provide aggregated summaries and aspect scores for unstructured textual data, in accordance with an embodiment.

FIG. 21 further illustrates an example use of the system to provide aggregated summaries and aspect scores for unstructured textual data, in accordance with an embodiment.

FIG. 22 further illustrates an example use of the system to provide aggregated summaries and aspect scores for unstructured textual data, in accordance with an embodiment.

FIG. 23 further illustrates an example use of the system to provide aggregated summaries and aspect scores for unstructured textual data, in accordance with an embodiment.

FIG. 24 illustrates an example user interface and interaction with the system, in accordance with an embodiment.

FIG. 25 illustrates an example user interface and interaction with the system, in accordance with an embodiment.

FIG. 26 further illustrates an example user interface and interaction with the system, in accordance with an embodiment.

FIG. 27 illustrates an example use of the system in augmenting a vector database, for subsequent use in processing data, in accordance with an embodiment.

### DETAILED DESCRIPTION

Generally described, data analytics systems and methods enable the computer-based examination of an amount of data, to derive an analytic data, metrics, conclusions, or other types of analytical information from, or descriptive of, the source data. Such data analytics environments can be used, for example, to generate an analytic business intelligence data, such as a set of data metrics or measures operating as key performance indicators, which analytically describe an organization's business-related data in a format useful to its decision-makers.

Increasingly, various data analytics environments have adopted the use of large language models in their analytics offerings, for example with regard to parsing a user-provided input or a reference text. However, typical approaches to using large language models are less successful at interpreting context, or extracting quantifiable metrics with justification. For example, such approaches generally lack the sophistication required for semantic searching, and may not consider nuanced concepts or sentiments within an input or reference text. The limitations associated with such approaches become increasingly evident when attempting to aggregate or summarize large amounts of unstructured textual data.

Embodiments described herein are generally related to data analytics environments, and to systems and methods for providing aggregated summaries and aspect scores associated with unstructured textual data.

In accordance with an embodiment, the system uses a key-based or batch approach that assesses factors associated with an unstructured textual dataset, such as, for example, a total number of text entries per key, or the character length of each text entry. Based on a consideration of such factors, the system sends batches of text entries, and a prompt, to a large language model processor, to collect intermediate batch results. The intermediate batch results can be used first to develop a numerical score or summary for each key, directed to various aspects of interest within the data; and subsequently to generate aggregated summaries and/or aspect scores associated with the textual dataset, for use in displaying visualizations or returning additional analytical information.

In accordance with an embodiment, technical features and advantages of the systems and methods described herein include that the system can leverage the capabilities of an LLM to interpret and quantify nuanced or non-quantifiable aspects of unstructured textual data. For example, an LLM can be used to enrich unstructured text with quantitative data, generate justifications for assessments, and utilize context clues that improve upon keyword dependency. The described approach provides a means of assessing and scoring large datasets comprising textual data, to produce aggregated textual summaries and numerical ratings.

In accordance with an embodiment, the described approach can be used to increase the efficient operation of LLMs in processing large amounts of unstructured textual data by:
(1) Using an N-step approach that gradually reduces the amount of data for each key, wherein the results are then combined into a final result of each key, and wherein each of the N calls can be made in parallel to enhance the speed of execution;
(2) Providing a set of LLM prompts that are able to assist in providing an accurate summarization of disparate entries, and in generating numerical ratings for each user-provided aspect or sentiment; and
(3) Post-processing the numerical ratings to obtain a weighted average based on confidence scores associated with the LLM results.

In accordance with an embodiment, the systems and methods described herein can be used with additional or other functionalities, such as, for example, a data flow engine, an external data sources connection, a generative-AI service, or other types of systems or services, to integrate such functionalities with an LLM environment, for use in generating quantitative data from unstructured textual data, for improved decision-making or other data analytics purposes.

### Cloud Infrastructure and Data Analytics Environments

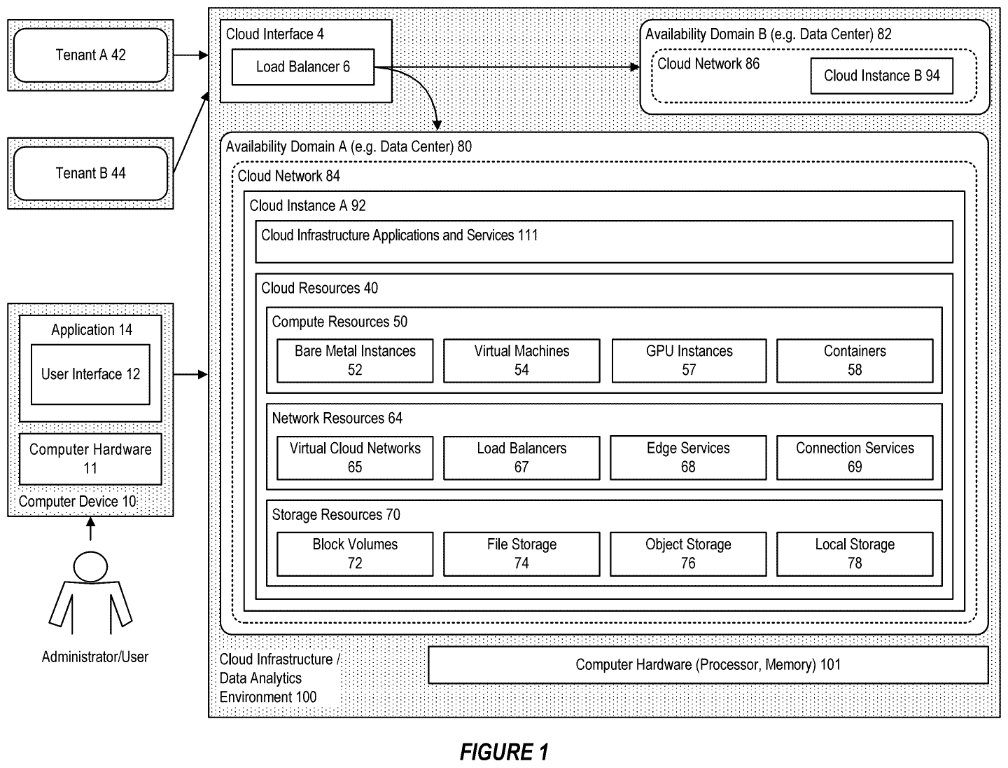

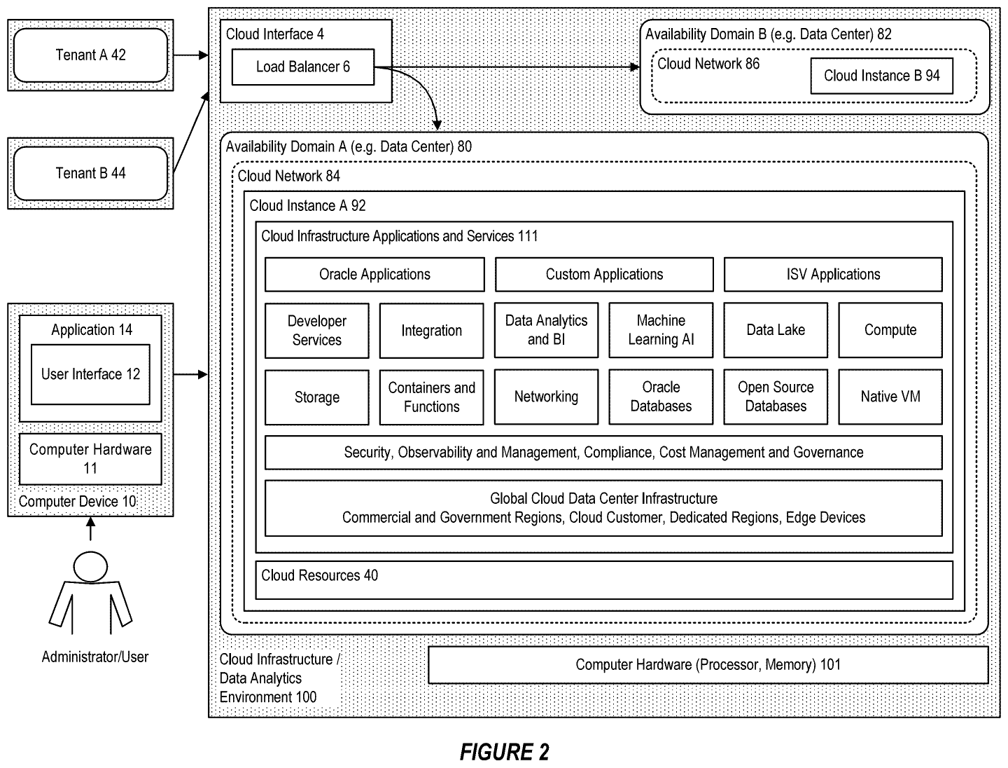

FIGS. 1 and 2 illustrate a system for providing a cloud infrastructure or data analytics environment, in accordance with an embodiment.

In accordance with an embodiment, the components and processes illustrated in FIG. 1, and as further described herein with regard to various embodiments, can be provided as software or program code executable by a computer system or other type of processing device, for example a cloud computing system, or other suitably-programmed computer system.

The illustrated example is provided for purposes of illustrating a computing environment which can be used to provide cloud environments for use by tenants in accessing subscription-based software products, services, or other offerings associated with a cloud infrastructure environment. In accordance with other embodiments, the various components, processes, and features described herein can be used with other types of cloud computing environments.

As illustrated in FIG. 1, in accordance with an embodiment, a cloud infrastructure or data analytics environment 100 can operate on a cloud computing infrastructure 101 comprising hardware (e.g., processor, memory), software resources, and one or more cloud interfaces 4 or other application program interfaces (API) that provide access to the shared cloud resources via one or more load balancers 6.

In accordance with an embodiment, the cloud infrastructure environment supports the use of availability domains, such as, for example, availability domains A 80, B 82, which enables customers to create and access cloud networks 84, 86, and run cloud instances A 92, B 94.

In accordance with an embodiment, a tenancy can be created for each cloud tenant/customer, for example tenant A 42, B 44, which provides a secure and isolated partition within the cloud infrastructure environment within which the customer can create, organize, and administer their cloud resources. A cloud tenant/customer can access an availability domain and a cloud network to access each of their cloud instances.

In accordance with an embodiment, a client device, such as, for example, a computing device 10 having a device hardware 11 (e.g., processor, memory), application 14 and graphical user interface 12, can enable an administrator other user to communicate with the cloud infrastructure environment via a network such as, for example, a wide area network, local area network, or the Internet, to create or update cloud services.

In accordance with an embodiment, the cloud infrastructure environment provides access to shared cloud resources 40 via, for example, a compute resources layer 50, a network resources layer 64, and/or a storage resources layer 70. Customers can launch cloud instances as needed, to meet compute and application requirements. After a customer provisions and launches a cloud instance, the provisioned cloud instance can be accessed from, for example, a client device.

In accordance with an embodiment, the compute resources layer can comprise resources, such as, for example, bare metal cloud instances 52, virtual machines 54, graphical processing unit (GPU) compute cloud instances 57, and/or containers 58. The compute resources layer can be used to, for example, provision and manage bare metal compute cloud instances, or provision cloud instances as needed to deploy and run applications, as in an on-premises data center.

For example, in accordance with an embodiment, the cloud infrastructure environment can provide control of physical host (bare metal) machines within the compute resources layer, which run as compute cloud instances directly on bare metal servers, without a hypervisor.

In accordance with an embodiment, the cloud infrastructure environment can also provide control of virtual machines within the compute resources layer, which can be launched, for example, from an image, wherein the types and quantities of resources available to a virtual machine cloud instance can be determined, for example, based upon the image that the virtual machine was launched from.

In accordance with an embodiment, the network resources layer can comprise a number of network-related resources, such as, for example, virtual cloud networks (VCNs) 65, load balancers 67, edge services 68, and/or connection services 69.

In accordance with an embodiment, the storage resources layer can comprise a number of resources, such as, for example, data/block volumes 72, file storage 74, object storage 76, and/or local storage 78.

In accordance with an embodiment, the cloud environment can include a container orchestration system, and container orchestration system API, that enables containerized application workflows to be deployed to a container orchestration environment, for example a Kubernetes (k8s) cluster.

For example, in accordance with an embodiment, the cloud environment can be used to provide containerized compute cloud instances within the compute resources layer, and a container orchestration implementation (e.g., Oracle Cloud Infrastructure Container Engine for Kubernetes (OKE)), can be used to build and launch containerized applications or cloud-native applications, specify compute resources that the containerized application requires, and provision the required compute resources.

As illustrated in FIG. 2, in accordance with an embodiment, the cloud infrastructure or data analytics environment can include a range of complementary cloud-based components, for example as cloud infrastructure applications and services 111, that enable organizations or enterprise customers to operate their applications and services in a highly-available hosted environment.

By way of example, in accordance with an embodiment, a self-contained cloud region can be provided as a complete, e.g., Oracle Cloud Infrastructure (OCI) dedicated region within an organization's data center that offers the data center operator the agility, scalability, and economics of a public cloud, while retaining full control of their data and applications to meet security, regulatory, or data residency requirements.

### Data Analytics Environments

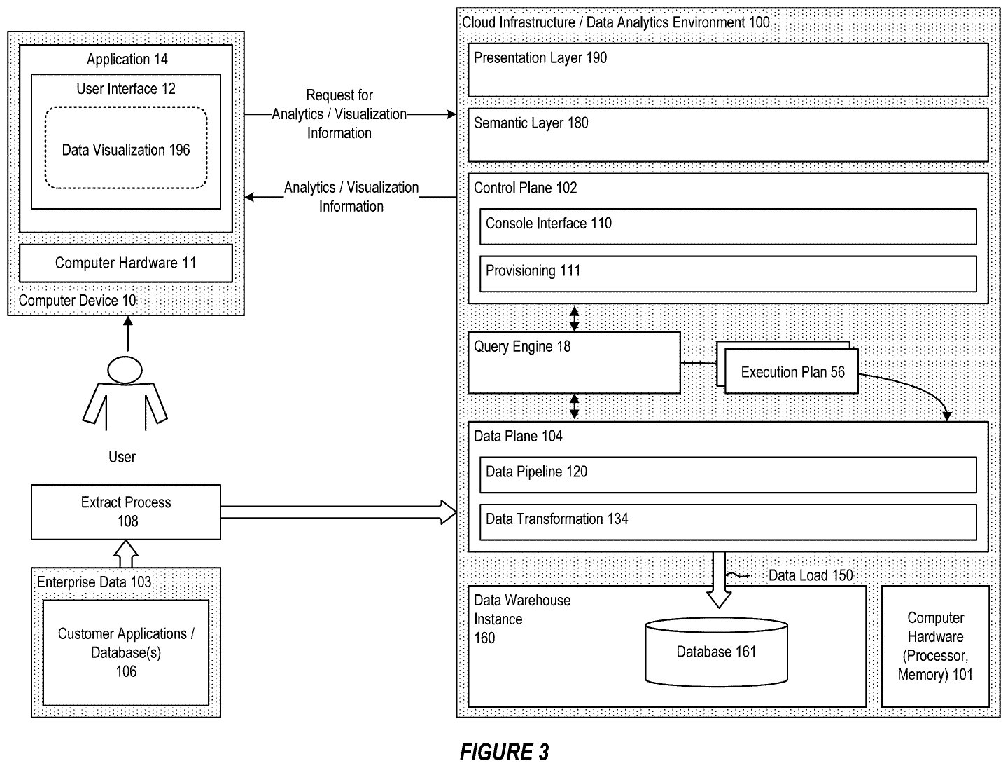

FIG. 3 illustrates an example use of the system to provide a data analytics environment, in accordance with an embodiment.

The example embodiment illustrated in FIG. 3 is provided for purposes of illustrating an example of a data analytics environment in association with which various embodiments described herein can be used. In accordance with other embodiments and examples, the approach described herein can be used with other types of data analytics, database, or data warehouse environments.

As illustrated in FIG. 3, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access in the manner of a data layer to a data warehouse instance 160 (e.g., having a database 161, or other type of data source).

In accordance with an embodiment, the control plane operates to provide control for cloud or other software products offered within the context of a cloud environment. For example, in accordance with an embodiment, the control plane can include a console interface 110 that enables access by a customer (tenant) and/or a cloud environment having a provisioning component 111, for example to allow customers to provision services for use within their enterprise environment. The provisioning component can provision a data warehouse instance, including a customer schema of the data warehouse; and populate the data warehouse instance with the appropriate information supplied by the customer.

In accordance with an embodiment, the data plane can include a data pipeline or process layer 120 and a data transformation layer 134, that together process data from an organization's enterprise software environment, and load a transformed data into the data warehouse. The data transformation layer can include a data model, such as, for example, a knowledge model (KM), or other type of data model, that the system uses to transform the data received from business applications and corresponding databases, into a model format understood by the data analytics environment. The data plane is responsible for performing extract, transform, and load (ETL) operations, including extracting data from an organization's enterprise software environment, transforming the extracted data into a model format, and loading the transformed data into a customer schema of the data warehouse.

For example, in accordance with an embodiment, each customer (tenant) of the environment can be associated with their own customer schema; and can be additionally provided with read-only access to the data analytics schema, which can be updated by a data pipeline or process, for example, an ETL process, on a periodic or other basis. For example, a data pipeline or process can be scheduled to execute at intervals (e.g., hourly/daily/weekly) to extract enterprise data 103 from an enterprise software environment, such as, for example, business productivity software applications and corresponding databases 106.

In accordance with an embodiment, an extract process 108 can extract the data, whereupon extraction the data pipeline or process can insert extracted data into a data staging area, which can act as a temporary staging area for the extracted data. When the extract process has completed its extraction, the data transformation layer can be used to transform the extracted data into a model format to be loaded into the customer schema of the data warehouse. During the data transformation, the system can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers may have different requirements with regard to how their data is classified, aggregated, or transformed, for providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a customer may perform modifications to their data source model, to support their particular requirements, for example by adding custom facts or dimensions associated with the data stored in their data warehouse instance; and the system can extend the semantic model accordingly. A semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, the presentation layer can enable access to the data content using, for example, a software analytic application, user interface, analytics dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an Oracle Business Intelligence Server, OBIS instance) operates in the manner of a federated query engine to serve analytical queries or requests from clients directed to data stored at a database. The query engine can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query.

In accordance with an embodiment, a user/developer can interact with a client computer device 10 that includes a computer hardware 11 (e.g., processor, storage, memory), user interface 12, and client application 14. A query engine or business intelligence server generally operates to process inbound, e.g., SQL, requests against a database model, build and execute one or more physical database queries, process the data appropriately, and return the data in response to the request.

To accomplish this, in accordance with an embodiment, the query engine can include a logical or business model, or metadata, that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, the query engine may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine can process queries against a database according to a query execution plan. During operation the query engine can create a query execution plan which can then be further optimized, for example to perform aggregations of data necessary to respond to a request. Data can be combined together and further calculations applied, before the results are returned to the calling application.

In accordance with an embodiment, a request for data analytics or visualization information can be received via a client application and user interface as described above, and communicated to the data analytics environment (in the example of a cloud environment, via a cloud service). The system can retrieve an appropriate dataset to address the user/business context, for use in generating and returning the requested data analytics or visualization information to the client, as a data visualization 196.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the data analytics environment, or in the example of a cloud environment via a cloud service provided by the environment.

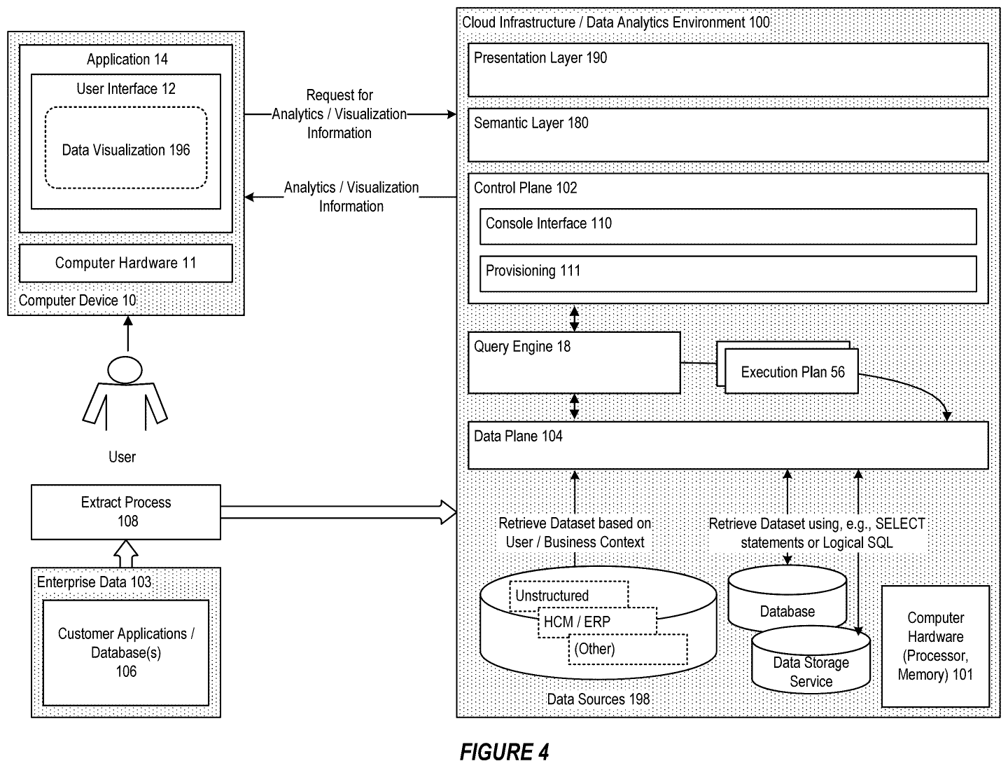

FIG. 4 further illustrates an example data analytics environment, in accordance with an embodiment.

As illustrated in FIG. 4, in accordance with an embodiment, the data analytics environment enables a dataset to be retrieved, received, or prepared from one or more data source(s) 198, for example via one or more data source connections. Examples of the types of data that can be transformed, analyzed, or visualized using the systems and methods described herein include data directed to Enterprise Resource Planning (ERP), Human Capital Management (HCM), or Human Resources (HR), or other types of data provided at one or more of a database, data storage service, or other type of data repository or data source.

For example, in accordance with an embodiment, a request for data analytics or visualization information can be received via a client application and user interface as described above, and communicated to the data analytics environment, for example via a cloud service. The system can retrieve an appropriate dataset to address the user/business context, for use in generating and returning the requested data analytics or visualization information to the client.

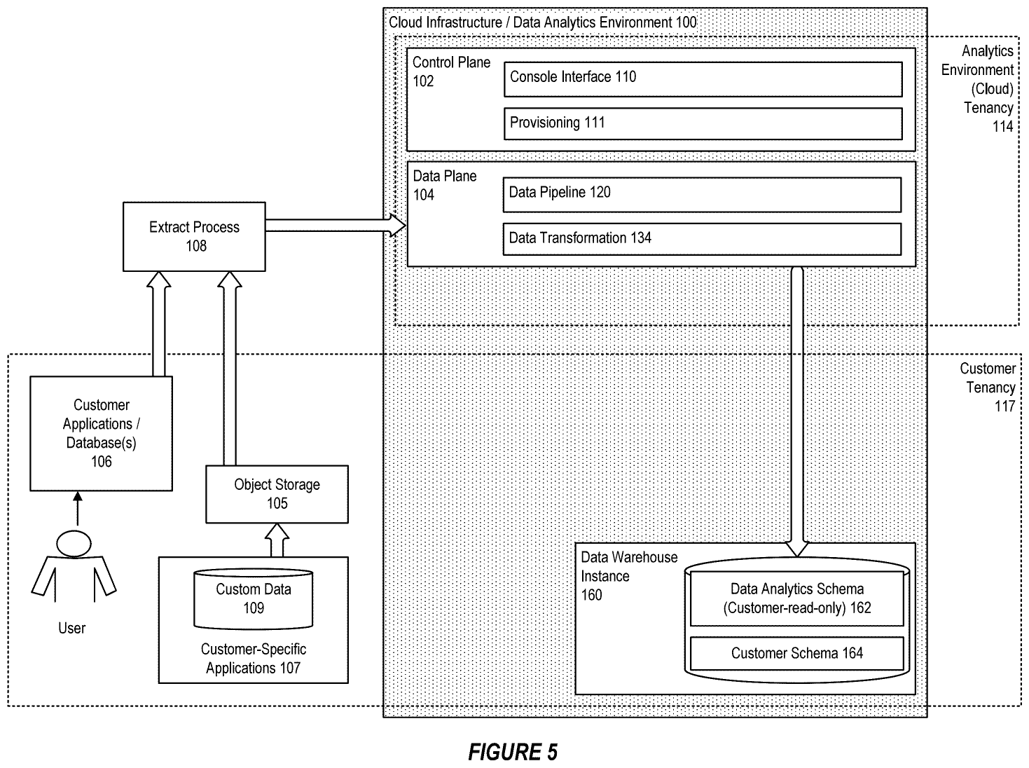

FIG. 5 further illustrates an example data analytics environment, in accordance with an embodiment.

As illustrated in FIG. 5, in accordance with an embodiment, data can be sourced, e.g., from a customer's (tenant's) enterprise software environment (106), using the data pipeline process; or as custom data 109 sourced from one or more customer-specific applications 107; and loaded to a data warehouse instance, including in some examples the use of an object storage 105 for storage of the data. A user can create a dataset that uses tables from different connections and schemas. The system uses the relationships defined between these tables to create relationships or joins in the dataset.

In accordance with an embodiment, the data warehouse can include a default data analytics schema 162 and, for each customer (tenant) of the system, a customer schema 164. For each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse can include a data analytics schema and, for each customer/tenant, a customer schema sourced from their enterprise software environment. The data provisioned in a data warehouse tenancy is accessible only to that tenant; while at the same time allowing access to various, e.g., ETL-related or other features of the shared environment.

In accordance with an embodiment, for a particular customer/tenant, upon extraction of their data, the data pipeline or process can insert the extracted data into a data staging area for the tenant, which can act as a temporary staging area for the extracted data. When the extract process has completed its extraction, the data transformation layer can be used to transform the extracted data into a model format to be loaded into the customer schema of the data warehouse.

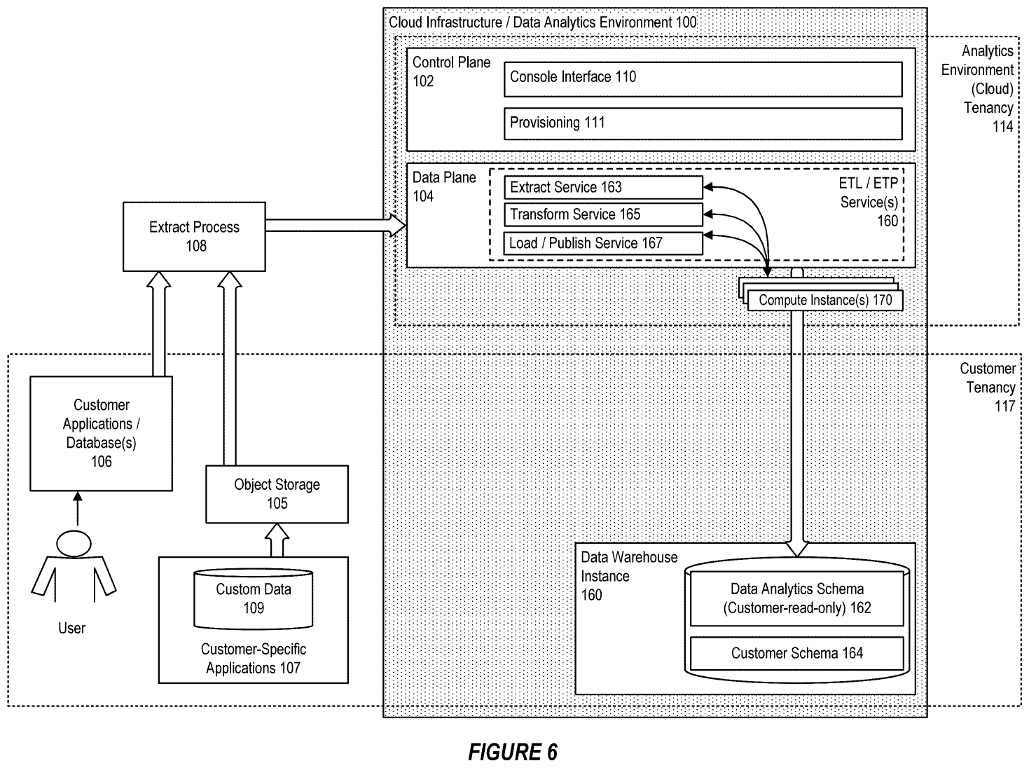

### FIG. 6 further illustrates an example data analytics environment, in accordance with an embodiment.

As illustrated in FIG. 6, in accordance with an embodiment, the process of extracting data from a customer's (tenant's) enterprise software environment, and loading the data to a data warehouse instance, or refreshing the data in a data warehouse, generally involves several stages, performed by an ETP service 160 or process, including one or more extraction service 163; transformation service 165; and load/publish service 167, executed by one or more compute instance(s) 170.

For example, in accordance with an embodiment, extracted files can be uploaded to an object storage component for storage of the data. The transformation process then applies a business logic while loading them to a target data warehouse, e.g., an Autonomous Data Warehouse (ADW) database, which is internal to the data pipeline or process, and is not exposed to the customer (tenant). A load/publish service or process takes the data from the ADW database and publishes it to a data warehouse instance that is accessible to the customer (tenant).

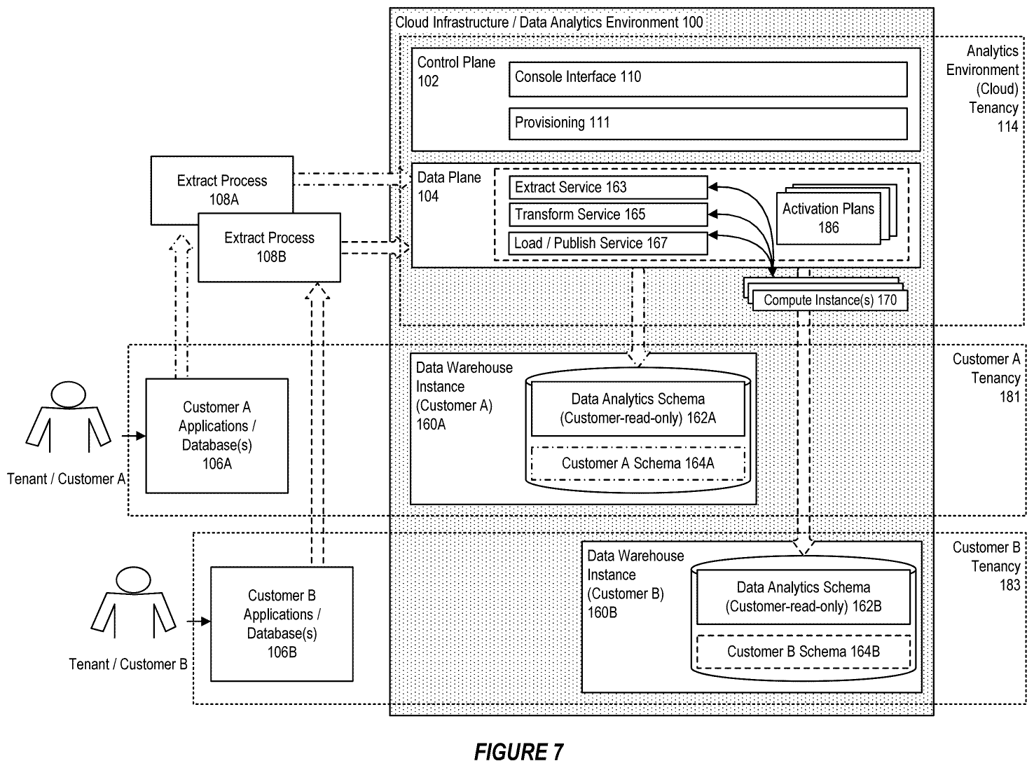

FIG. 7 further illustrates an example data analytics environment, in accordance with an embodiment.

As illustrated in FIG. 7, in accordance with an embodiment, the data pipeline or process maintains, for each of a plurality of customers (tenants), for example customer A 180, customer B 182, a data analytics schema that is updated on a periodic basis, by the system in accordance with best practices for a particular analytics use case. For each of a plurality of customers (e.g., customers A, B), the system uses the data analytics schema 162A, 162B, that is maintained and updated by the system, to pre-populate a data warehouse instance for the customer, based on an analysis of the data within that customer's enterprise applications environment 106A, 106B, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs. For example, an activation plan can define a number of extract, transform, and load (publish) services or steps to be run in a certain order, at a certain time of day, and within a certain window of time.

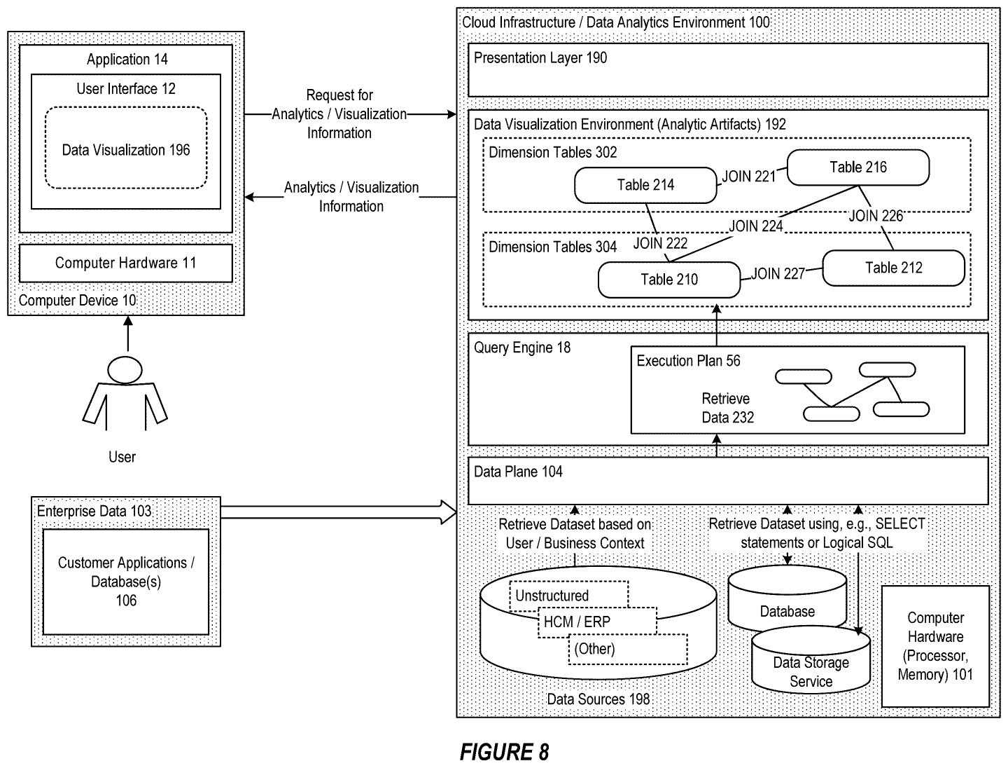

FIG. 8 further illustrates an example data analytics environment, in accordance with an embodiment.

Generally described, within a database or data warehouse, the data of interest may be spread across multiple tables. In such environments, joins can be used to stitch the data from various tables together, to better prepare the data for analysis.

For example, as illustrated in FIG. 8, in accordance with an embodiment, the data analytics environment enables a dataset to be retrieved, received, or prepared from one or more data source(s), for example via one or more data source connections, fact and/or dimension tables 210-216, or joins 221-227 between selections of dimension tables 302, 304.

In accordance with an embodiment, a request received at a data visualization environment to display analytic artifacts 192, for example as may be related to key performance indicators, analytics dashboards, or scorecards, can be received via a client application and user interface as described above, and communicated to the data analytics environment via a cloud service. The system can retrieve 232 an appropriate dataset using, e.g., SELECT statements, to address the user/business context, for use in generating and returning the requested data analytics or visualization information to the client.

### Large Language Models (LLM)

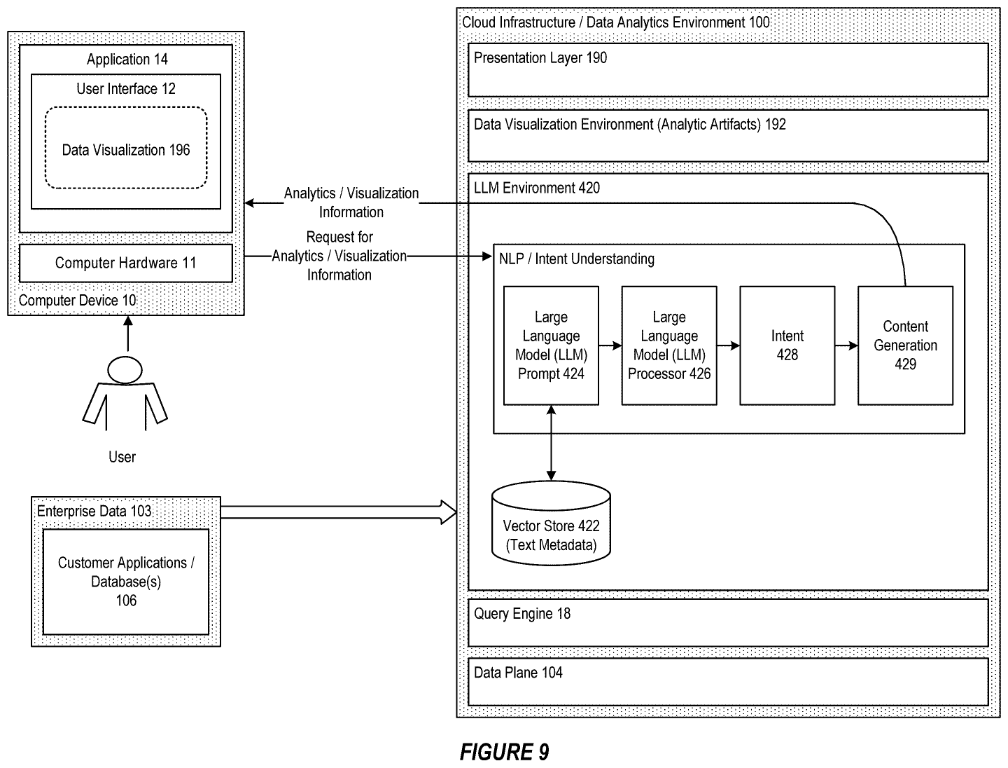

FIG. 9 further illustrates an example data analytics environment, including the use of a large language model, in accordance with an embodiment.

As illustrated in FIG. 9, in accordance with an embodiment, a data analytics system can include a large language model (LLM) environment 420. A vector database 422 provides storage and retrieval of vectors or vector embeddings, which in turn enables LLMs to understand information with increased context and accuracy, for example in generating a requested data analytics information or data visualization.

accordance with an embodiment, the system can parse a user query or natural language input, infer an intent 428 based on one or more large language model (LLM) prompt 424 or LLM processor 426, and then determine, for example, which subject areas may be relevant to the inferred intent, and generate or return an appropriate content 429.

### Retrieval-Augmented Generation (RAG)

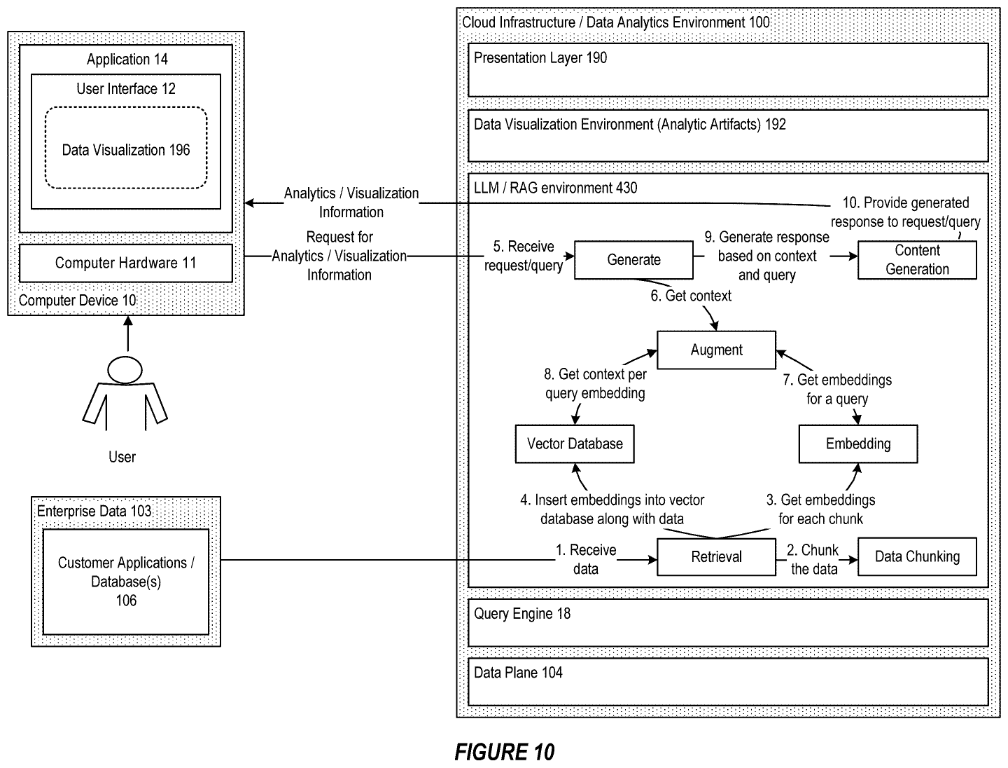

FIG. 10 further illustrates an example data analytics environment, including the use of retrieval-augmented generation, in accordance with an embodiment.

As illustrated in FIG. 10, in accordance with an embodiment, a data analytics system can include the use of retrieval-augmented generation (RAG) environment 430 that optimizes the output of a large language model (LLM) with targeted information, to provide a more contextually appropriate content in response to a user query.

In accordance with an embodiment, during the retrieval process::
Enterprise data can be received (1) in various formats, for example, as PDF, TXT, CSV, XML, or JSON documents, via REST, File, or other protocols.
The enterprise data or documents is broken into a plurality of segment or chunks (2).
Vector embeddings are obtained for each chunk of data (3), for example by calling a generative AI embedding service, or by using an embedding model.
The vector embeddings associated with the chunks of data are stored in a vector database, along with the data (4).

In accordance with an embodiment, during the augmented generation process:
The system can receive from a user, a data request or query, or a natural language input (5).
The system invokes an augmentation process or service to obtain the context for the request or query (6).

An embedding service is used to get the vector embeddings of the query data (7).
The augmentation process or service can obtain additional context based on a semantic search of the query data and its vector embedding (8).

The system can then generate an appropriate response based on the context and query (9); and return the generated response to the user (10).

The above example is provided for purpose of illustrating an example of a data analytics environment that includes the use of retrieval-augmented generation. In accordance with other embodiments, the system can include other forms of retrieval-augmented generation, which in turn can include different or other components or processes.

### Aggregated Summaries and Aspect Scores

As described above, various data analytics environments have adopted the use of large language models in their analytics offerings, for example with regard to parsing a user-provided input or a reference text.

However, typical approaches to using large language models are less successful at interpreting context, or extracting quantifiable metrics with justification. For example, such approaches generally lack the sophistication required for semantic searching, and may not consider nuanced concepts or sentiments within an input or reference text. The limitations associated with such approaches become increasingly evident when attempting to aggregate or summarize large amounts of unstructured textual data.

In accordance with an embodiment, described herein is a system and method for providing aggregated summaries and aspect scores associated with unstructured textual data.

The described approach leverages the advanced capabilities of large language models to interpret and quantify nuanced, non-quantifiable aspects of unstructured textual data, including the use of algorithms and comprehensive scoring to process large amount of textual data supplied in the form of analytics datasets, to produce aggregated textual summaries and numerical ratings.

In accordance with an embodiment, the system uses a key-based or batch approach that assesses factors associated with an unstructured textual dataset, such as, for example, a total number of text entries per key, or the character length of each text entry.

Based on a consideration of such factors, the system sends batches of text entries, and a prompt, to a large language model processor, to collect intermediate batch results.

The intermediate batch results can be used first to develop a numerical score or summary for each key, directed to various aspects of interest within the data; and subsequently to generate aggregated summaries and/or aspect scores associated with the textual dataset, for use in displaying visualizations or returning additional analytical information.

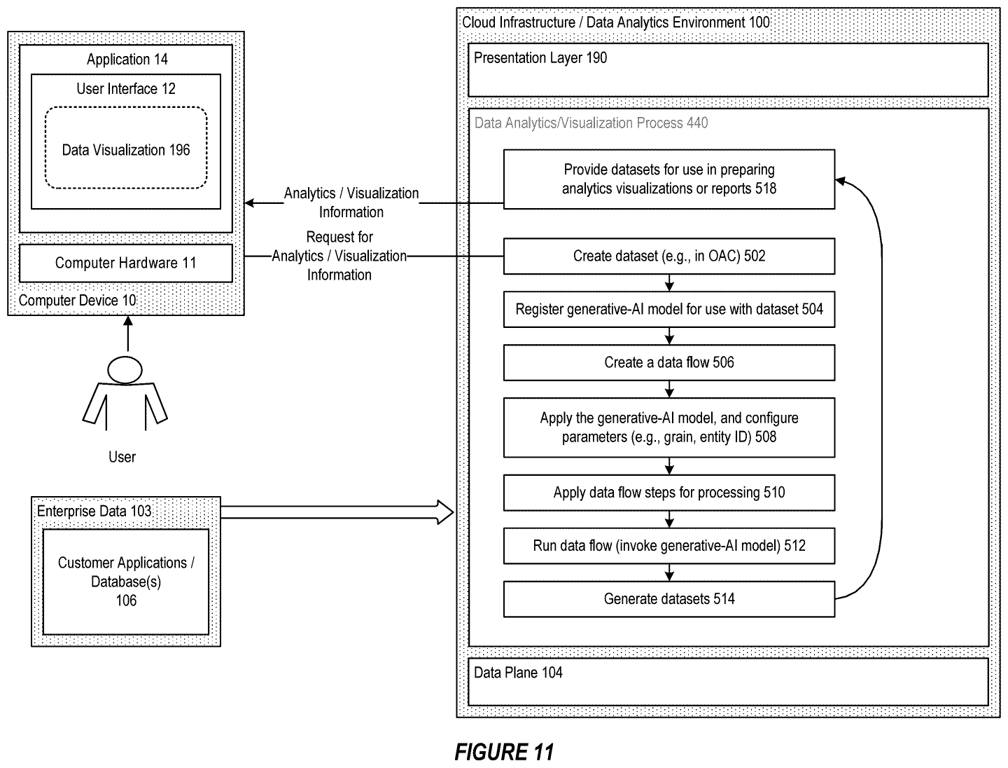

FIG. 11 illustrates a system for providing aggregated summaries and aspect scores associated with unstructured textual data, in accordance with an embodiment.

When working with large amounts of unstructured textual data, such as for example, travel-related hotel reviews, opinion polls and surveys, or medical summaries, one of the challenges is that-although the unstructured textual data may include useful or perhaps subjective insights, it may be difficult to extract these insights as useful quantifiable information.

For example, a travel-related data flow may be used to generate a dataset stored within the system as columns of data reflecting hotel reviews. In such an example, a user may wish to obtain from the review, information regarding an aspect of interest, for example an indication of the overall cleanliness of a hotel.

However, typical approaches to using large language models may not be able to assess nuances, for example the reviewer's tone associated with particular hotel reviews, in order to quantify such aspects. Additionally, typical LLM's are not particularly adept at assessing many thousands of reviews efficiently.

In accordance with an embodiment, the approach described herein can be used to provide an objective or numerical interpretation of various aspects of interest within the data. Additionally, the described approach can make efficient use of LLMs in processing the large amounts of unstructured textual data, by scaling the processing to accommodate limitations posed by so LLMs in not being able to process large amounts of data at one time.

As illustrated in FIG. 11, in accordance with an embodiment, the system operates generally to: create a dataset (e.g., in OAC) (502); register a generative-AI model for use with the dataset (504); create a data flow (506); apply the generative-AI model, and configure parameters (e.g., grain, entity id) (508); apply data flow steps for processing (510); run the data flow (and invoke the generative-AI model) (512); generate datasets 514; and then provide the datasets for use in preparing data analytics visualizations (data visualizations) reports, or other types of useful information (518).

In accordance with an embodiment, the initial data flow or dataset may be used to define various aspects reflected within the data that the user is interested in assessing.

For example, a user can specify columns of data with user-defined attributes or tags. In other embodiments, a machine learning process can be used to automatically determine attributes, tags, or aspects that may likely be of interest. Using these indications, the system can operate to return a tabular dashboard or visualization that reflects the various aspects of interest as found within the data as a result of processing by the LLM.

In accordance with an embodiment, as the system sends batches of text entries to the large language model processor, to collect intermediate batch results, each preceding set of batches, and their LLM-based assessment, is used to form batches for the next pass.

In this manner, the LLM processor is eventually presented with the entire amount of unstructured textual data—albeit in batched amounts that are most efficiently processed by the LLM. For example, if a particular LLM processor has an input limit of, e.g., X=500 characters, the system can operate to create batches of text entries, including an LLM prompt, that remains within that (X=500) character limit; and to continue to create successive batches within that character limit.

In accordance with an embodiment, each of the batches can be processed in parallel, by one or more LLM processor instances, to generate summaries of each batch.

For example, although the particular text entries within a particular batch may be quite different in content or aspects from other text entries within that batch (e.g., positive versus negative reviews), the process operates to provide an overall summary (of the batch of text entries) that takes this into account.

In accordance with an embodiment, the LLM prompt can include a prompt or request to the LLM to provide a score value associated with an aspect of interest, and also a confidence level or weighting for that score. When the system subsequently aggregates the scores for summarization purposes, it can take the confidence level or weighting into account.

The process can then be repeatedly applied on the intermediate results, and similarly in parallel if appropriate, to create summaries (of summaries), until the entire amount of unstructured textual data has been processed, and the system can determine an aggregate summary or score.

Although the summaries of particular batches may likewise be quite different in content or aspects from the summaries of other batches, the process operates to provide an overall summary (of the batch summaries) that takes this into account. As with the above, the LLM can similarly provide for the batch summary a score value associated with an aspect of interest, and also a confidence level or weighting for that score.

Eventually the amount of batches to be processed is completed (i.e., becomes less than 2), at which point the process is complete. The intermediate batch results can be used first to develop a numerical score or summary for each key, directed to the various aspects of interest within the data; and subsequently to generate aggregated summaries and/or aspect scores associated with the textual dataset, for use in displaying visualizations or returning additional analytical information.

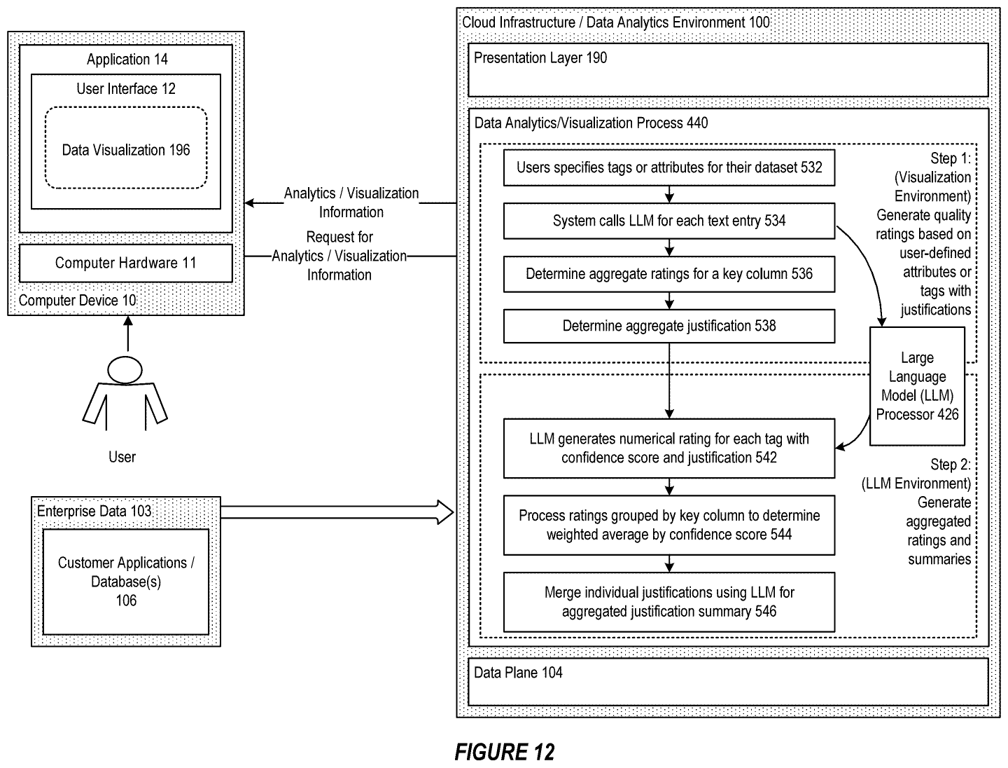

FIG. 12 further illustrates a system for providing aggregated summaries and aspect scores associated with unstructured textual data, in accordance with an embodiment.

As illustrated in FIG. 12, in accordance with an embodiment, the described approach can be used to increase the efficient operation of LLMs in processing large amounts of unstructured textual data by:
(1) Using an N-step approach that gradually reduces the amount of data for each key, wherein the results are then combined into a final result of each key, and wherein each of the N calls can be made in parallel to enhance the speed of execution;
(2) Providing a set of LLM prompts that are able to assist in providing an accurate summarization of disparate entries, and in generating numerical ratings for each user-provided aspect or sentiment; and
(3) Post-processing the numerical ratings to obtain a weighted average based on confidence scores associated with the LLM results.

Generally described, the system or process includes a data analytics/visualization process 440 that operates in two phases or steps, including, in a first phase or step 1 performed with a visualization environment: generating quality ratings based on user-defined attributes or tags with justifications; and in a second phase or step 2 performed in combination with an LLM environment: generating aggregated ratings and summaries.

In accordance with an embodiment, during the first phase or step: a user specifies tags or attributes for their dataset (532). The system calls the LLM for each text entry (534); determines aggregate ratings for a key column (536); and determines an aggregate justification (538).

In accordance with an embodiment, during the second phase or step, the LLM is used to generate a numerical rating for each tag, with a confidence score and justification (542). Process ratings are grouped by key column to determine a weighted average by confidence score (544). The system then merges individual justifications using the LLM, to provide an aggregated justification summary (546).

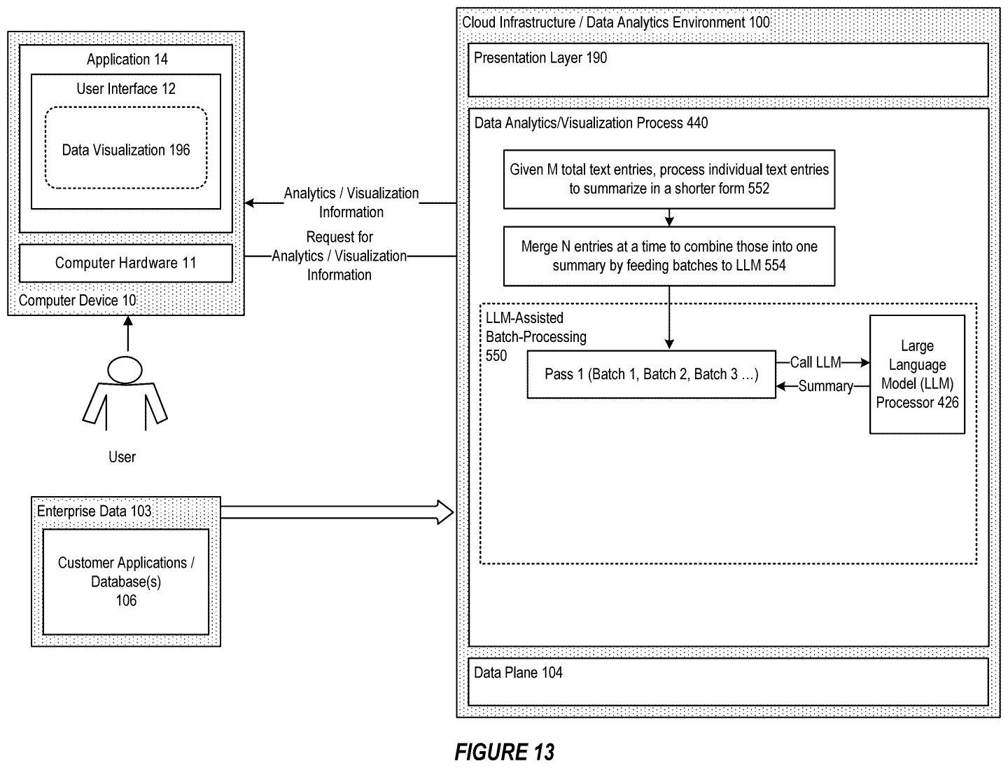

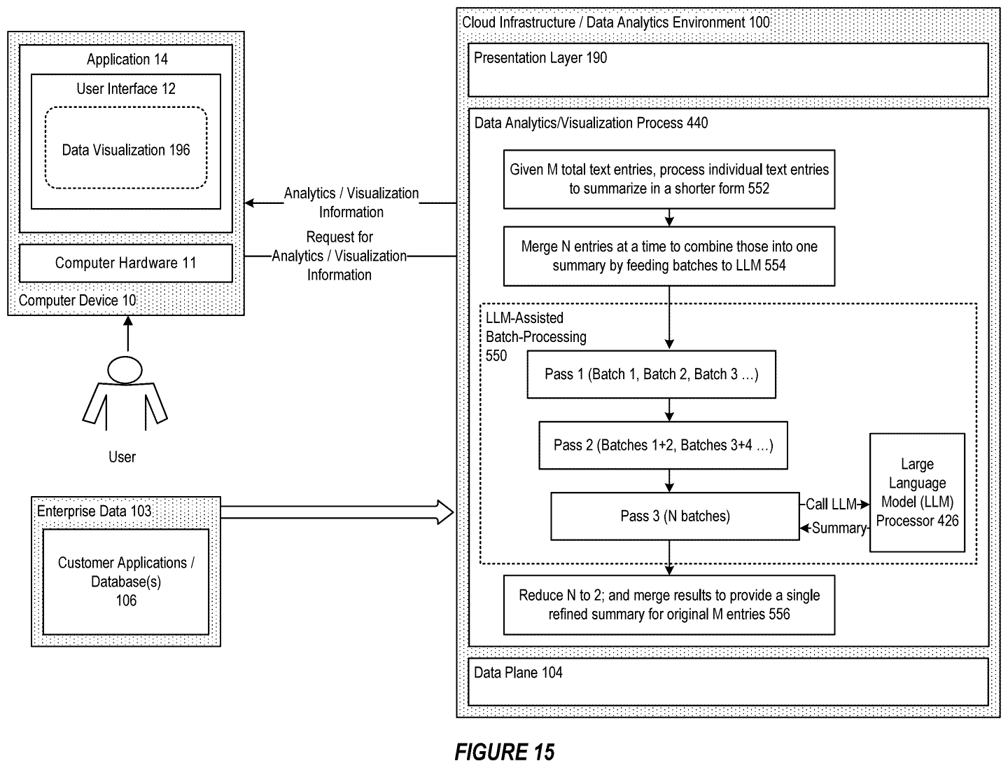

FIGS. 13-16 further illustrate a system for providing aggregated summaries and aspect scores associated with unstructured textual data, in accordance with an embodiment.

As illustrated in FIGS. 13-15, in accordance with an embodiment, during the process of LLM-assisted batch-processing 550, the system performs a process or algorithm as part of the data analytics/visualization process that operates to:
Given M total text entries, process individual text entries to summarize the entries in a shorter form (552).
Merge N entries at a time to combine those into one summary by feeding batches to one or more LLM processors (554).
Reduce N to 2; and merge to provide a single refined summary for the original M entries (556).

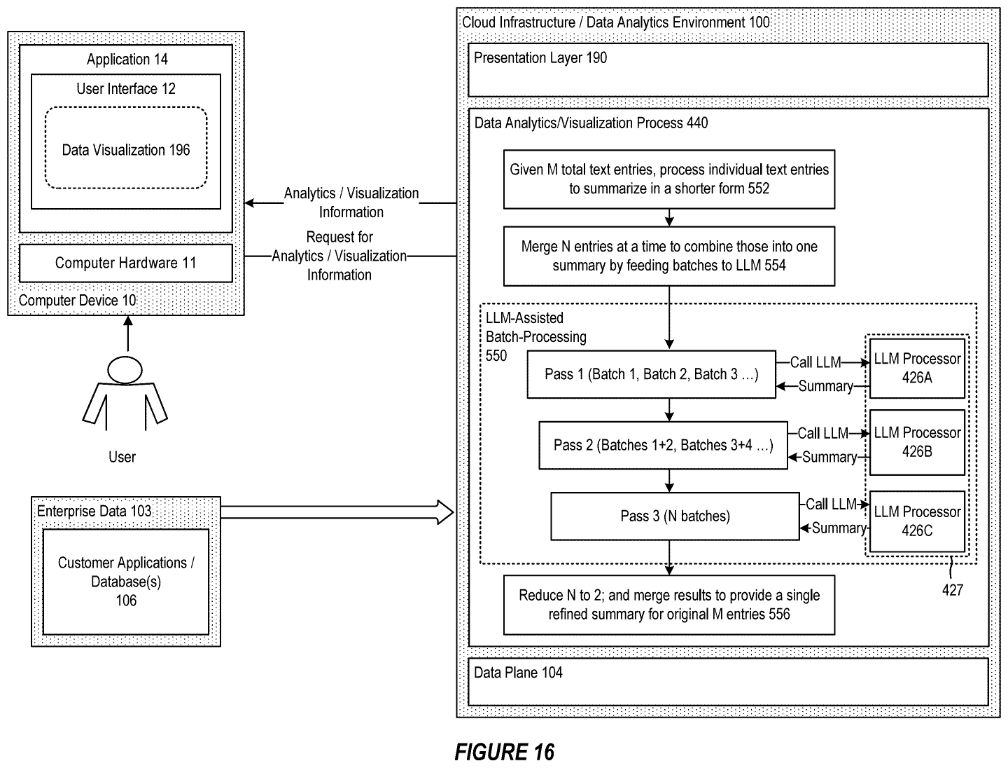

As illustrated in FIG. 16, in accordance with an embodiment, the system can make use of multiple LLM processor instances 427 if available; and each of the N calls can be made in parallel to enhance the speed of execution.

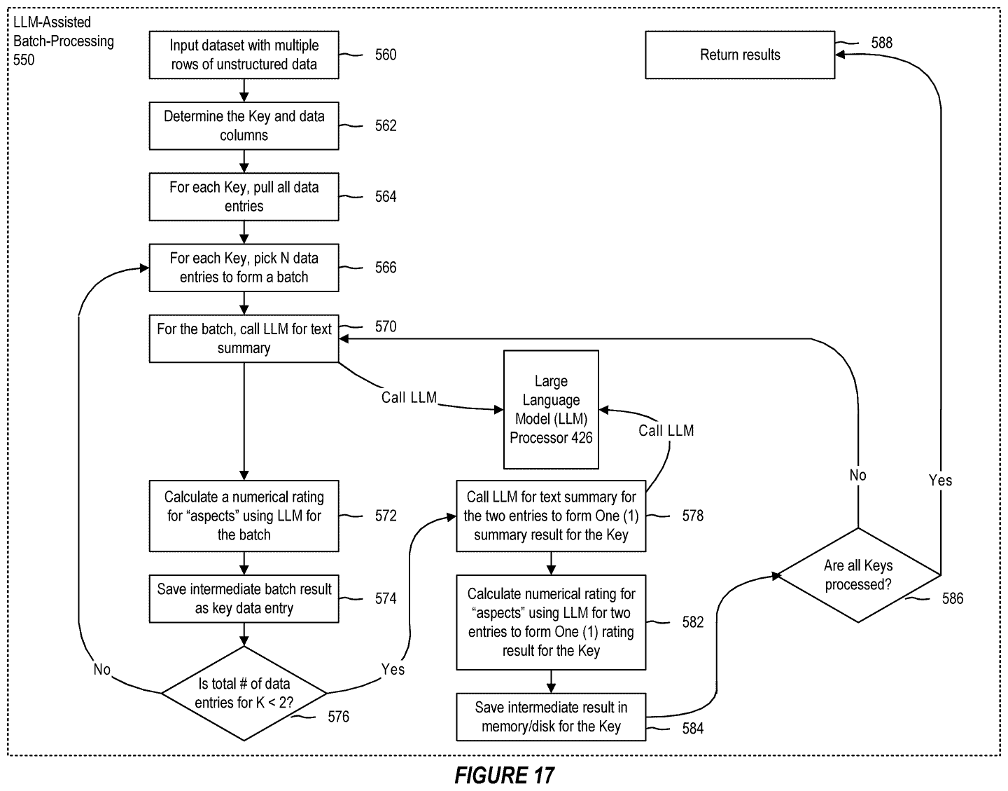

FIG. 17 illustrates a method for providing aggregated summaries and aspect scores associated with unstructured textual data, in accordance with an embodiment.

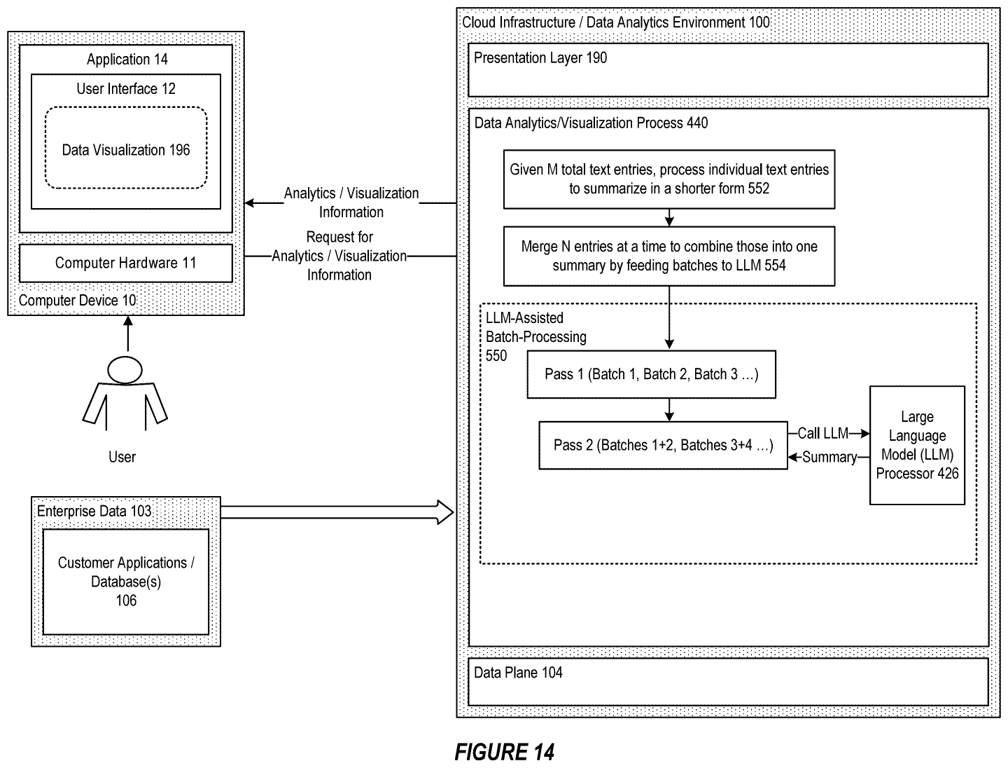

As illustrated in FIG. 14, in accordance with an embodiment, the method or process for LLM-assisted batch-processing 550 includes:

At step 560, the system receives an input dataset with multiple rows of unstructured data.

At step 562, the system determines the key and data columns associated with the input dataset.

At step 564, for each key, the system pulls all data entries.

At step 566, for each key, the system picks N data entries to form a batch.

At step 570, for the batch, the LLM is called to provide a text summary.

At step 572, the system calculate a numerical rating for “aspects” using the LLM for the batch.

At step 574, an intermediate batch result is saved as a key data entry.

At step 576, a determination is made whether the total number of data entries for k is less than 2; and if so then, at step 578, the LLM is called to provide a text summary for the two entries to form one (1) summary result for the key.

At step 582, the system calculates a numerical rating for “aspects” using the LLM for two entries to form one (1) rating result for the key.

At step 584, the intermediate result is saved in memory/disk for the key. The process can then be repeated for additional batches and keys.

At step 586, a determination is made whether all keys are processed; and if so, then at step 588, the system returns results, such as for example, aggregated summaries and aspect scores for the textual dataset, for use in displaying visualizations or returning additional analytical information.

### Use of Data Flows (Dataflows)

In accordance with an embodiment, the systems and methods described herein can be used with additional or other functionalities, such as, for example, a data flow engine, an external data sources connection, a generative-AI service, or other types of systems or services, to integrate such functionalities with an LLM environment, for use in generating quantitative data from unstructured textual data, for improved decision-making or other data analytics purposes.

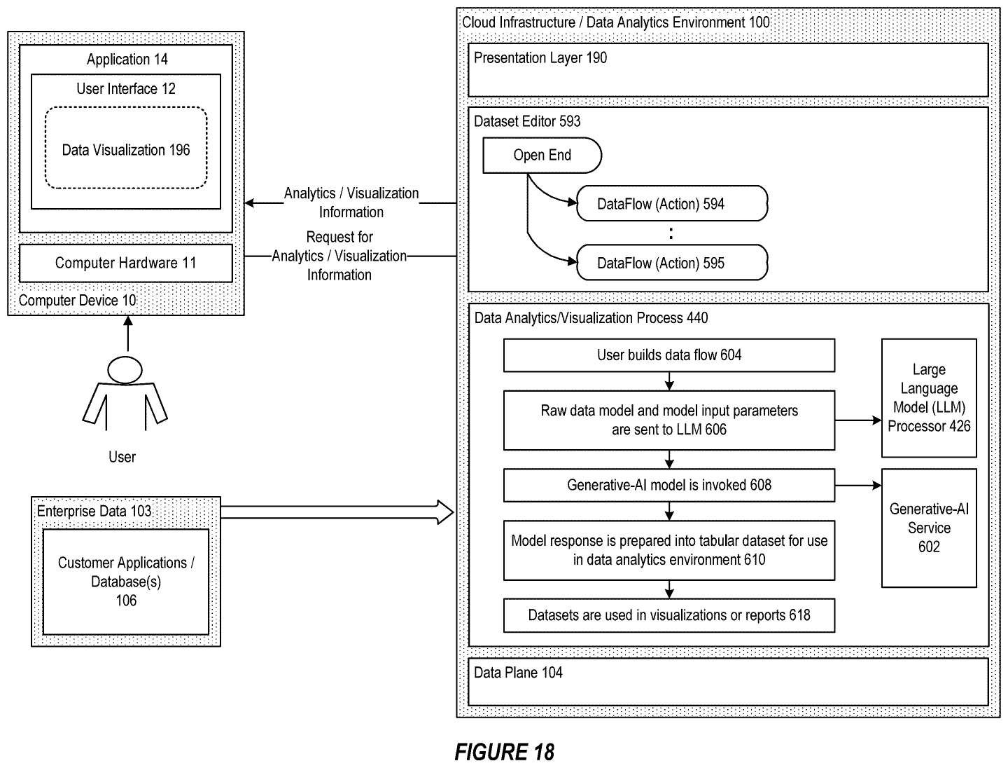

FIG. 18 illustrates an example use of the system in combination with a data flow, in accordance with an embodiment.

In accordance with an embodiment, the systems and methods disclosed herein can be used to provide a data visualization environment 192 that enables generation of data analytics, data visualizations (196), or other types of useful information associated with the data.

In accordance with an embodiment, the user interface can include or provide access to various data flow action (dataflow action) types that enable self-service text analytics, including allowing a user to display a dataset, or interact with the user interface to transform, analyze, or visualize the data, for example to generate graphs, charts, or other types of data analytics or visualizations of data flows.

In accordance with an embodiment, the system enables a dataset to be retrieved, received, or prepared from one or more data source(s), for example via one or more data source connections. Examples of the types of data that can be transformed, analyzed, or visualized using the systems and methods described herein include HCM, HR, or ERP data, e-mail or text messages, or other of free-form or unstructured textual data provided at one or more of a database, data storage service, or other type of data repository or data source.

For example, in accordance with an embodiment, a request for data analytics or visualization information can be received via a client application and user interface. The system can retrieve an appropriate dataset to address the user/business context, for use in generating and returning the requested data analytics or visualization information to the client. For example, the data analytics system can retrieve a dataset using, e.g., SELECT statements.

In accordance with an embodiment, the system can create a model or data flow that reflects an understanding of the data flow or set of input data, by applying various algorithmic processes, to generate visualizations or other types of useful information associated with the data. The model or data flow can be further modified within a dataset editor 593 by applying various processing or techniques to the data flow or set of input data, including for example one or more dataflow actions 594, 595 or steps that operate on the data flow or set of input data. A user can interact with the system via a user interface, to control the use of dataflow actions to generate data analytics, data visualizations (196), or other types of useful information associated with the data.

In accordance with an embodiment, datasets operate as self-service data models that a user can build for data visualization and analysis requirements. A dataset contains data source connection information, tables, and columns, data enrichments and transformations.

In accordance with an embodiment, a user can use data flows to create datasets by combining, organizing, and integrating data. Data flows enable the user to organize and integrate data to produce curated datasets that either they or other users can visualize. For example, in accordance with an embodiment, a user might use a data flow to create a dataset; combine data from different source; aggregate data; and train a machine learning model or apply a predictive machine learning model to their data.

In accordance with an embodiment, a dataset editor as described above allows a user to add actions or steps, wherein each step performs a specific function, for example, add data, join tables, merge columns, transform data, or save the output data from a data flow in either a dataset or in a supported database type.

For example, as illustrated in FIG. 18, in accordance with an embodiment, when used with a generative-ai service 602, the above-described approach can be used such that: a user builds a data flow (604). a raw data model and model input parameters are sent to an LLM processor (606). The generative-ai model is invoked (608). A model response is prepared into tabular dataset for use in data analytics environment (610). Resultant datasets can then be used in preparing data analytics, data visualizations, reports, or other types of useful information (618).

### Example Use with Unstructured Textual Data

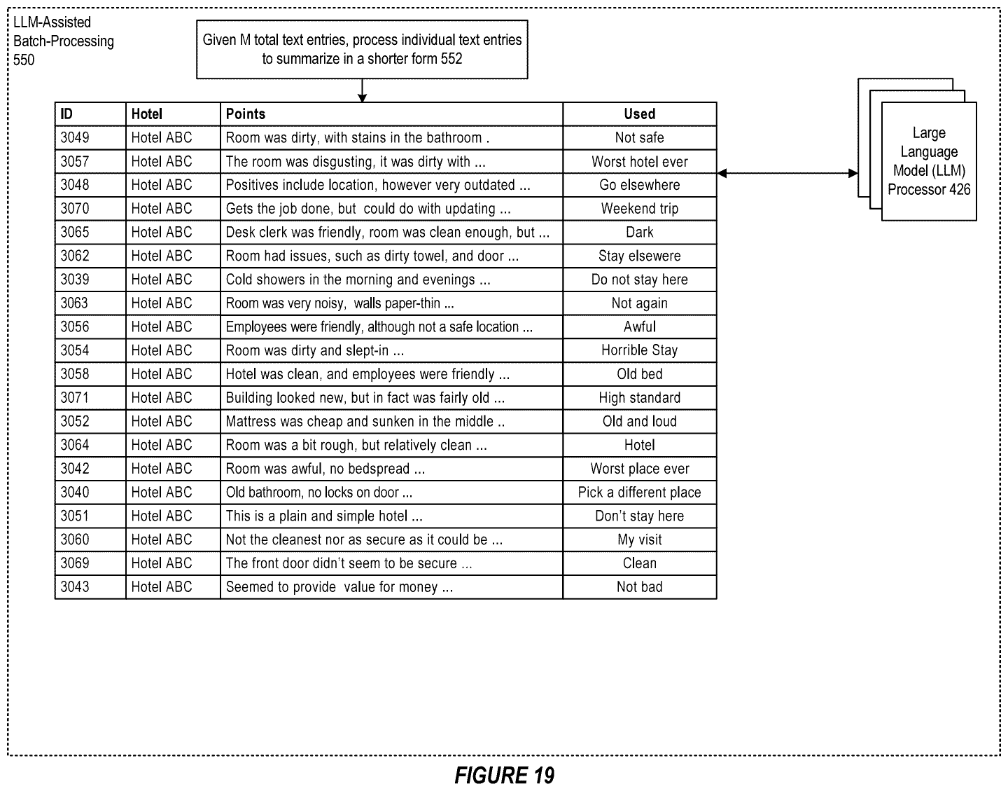

FIGS. 19-23 illustrate an example use of the system to provide aggregated summaries and aspect scores for unstructured textual data, in accordance with an embodiment.

By way of example, as illustrated in FIG. 19, in accordance with an embodiment, the system uses a key-based or batch approach that assesses factors associated with an unstructured textual dataset—in this example, a set of travel-related hotel reviews.

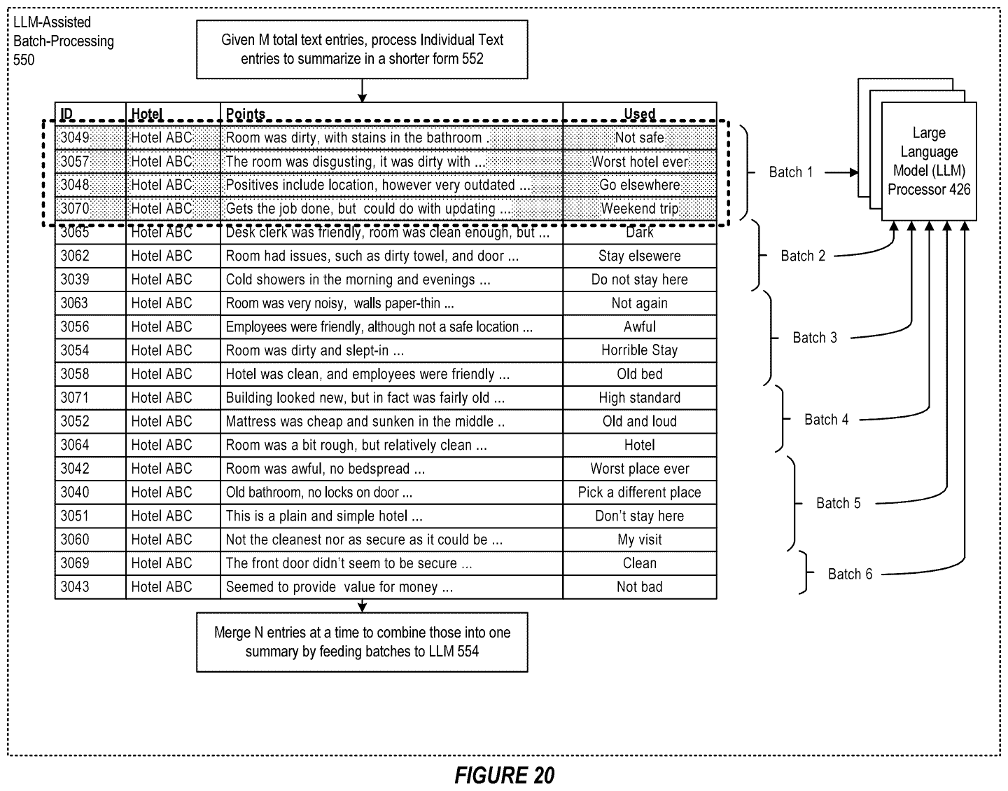

As illustrated in FIG. 20, based on a consideration of such factors, the system sends batches of text entries, and a prompt, to a large language model processor, to collect intermediate batch results.

In this example, the set of travel-related hotel reviews are formed into batches, and processed in a series of passes by one or more LLM processors, with each preceding set of batches, and their LLM-based assessment, used to form used to form batches for the next pass.

The intermediate batch results can be used first to develop a numerical score or summary for each key, directed to various aspects of interest within the data; and subsequently to generate aggregated summaries and/or aspect scores associated with the textual dataset, for use in displaying visualizations or returning additional analytical information.

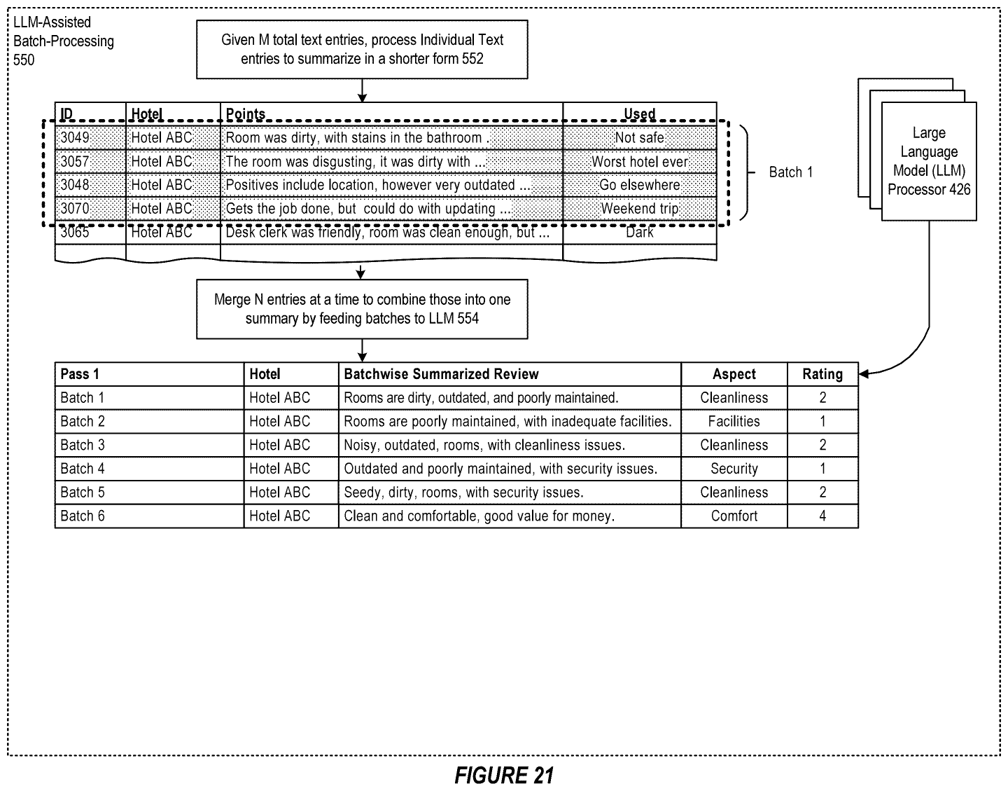

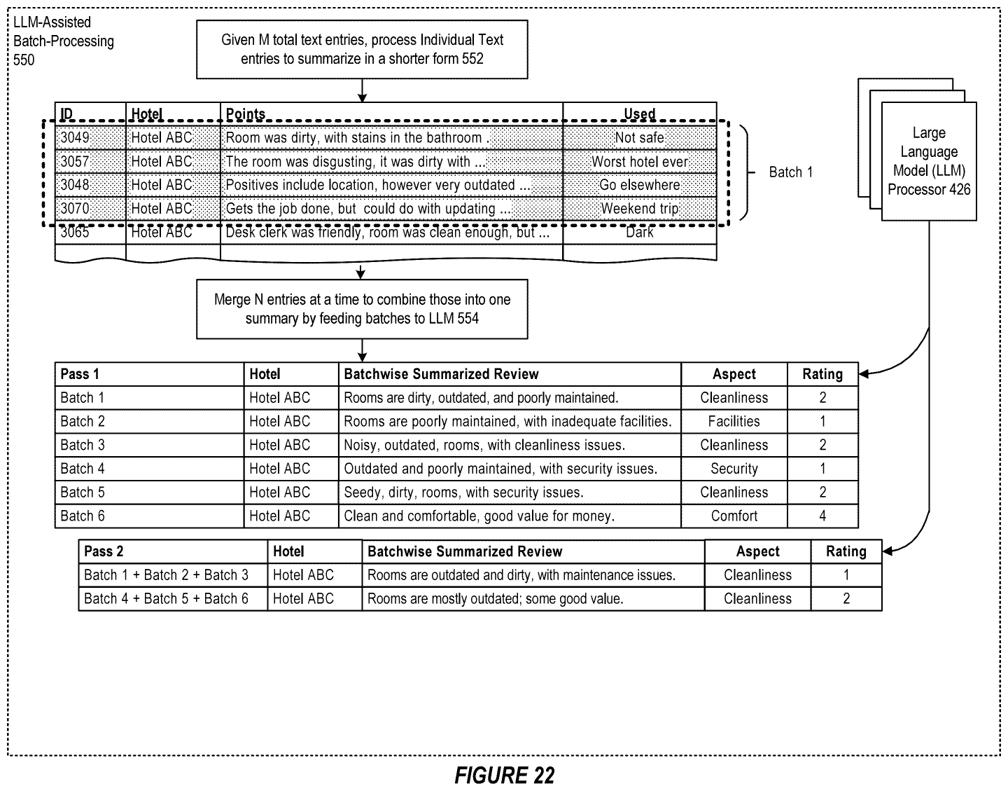

For example, as illustrated in FIG. 21-22, during each pass, the LLM is used to first summarize a batch of travel-related hotel reviews, and then to summarize batches of those batches (of travel-related hotel reviews) that reflect either user-specified or system-determined aspects such as, in this example, cleanliness, facilities, security, or comfort.

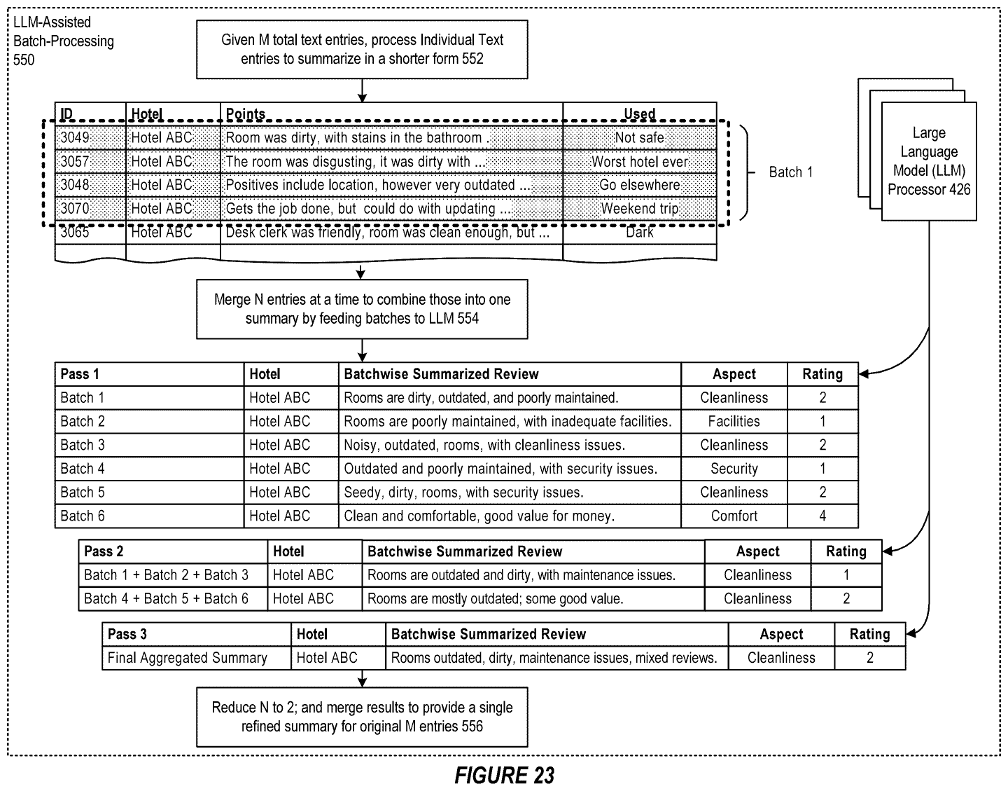

As illustrated in FIG. 23, the system can then provide an aggregated summary, for example that for Hotel ABC, its reviews in aggregate indicate “Rooms outdated, dirty, maintenance issues, mixed reviews”; and that it includes an aspect score for Cleanliness of “2”, based on the LLM processing of the contents of the original textual dataset.

### Example User Experience

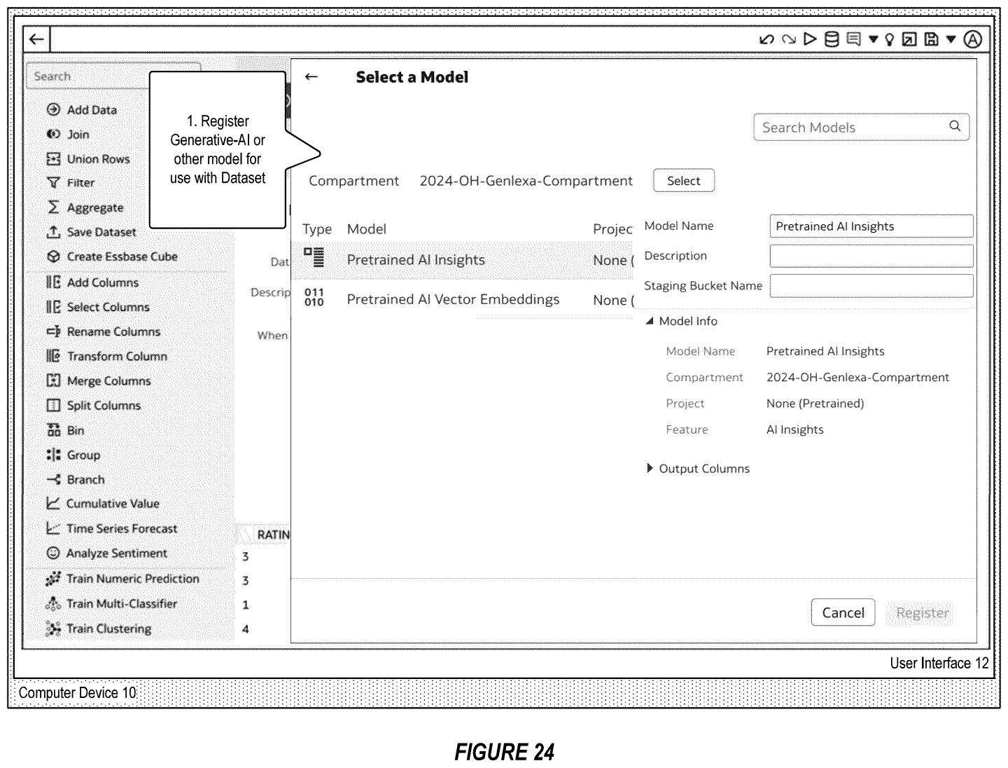

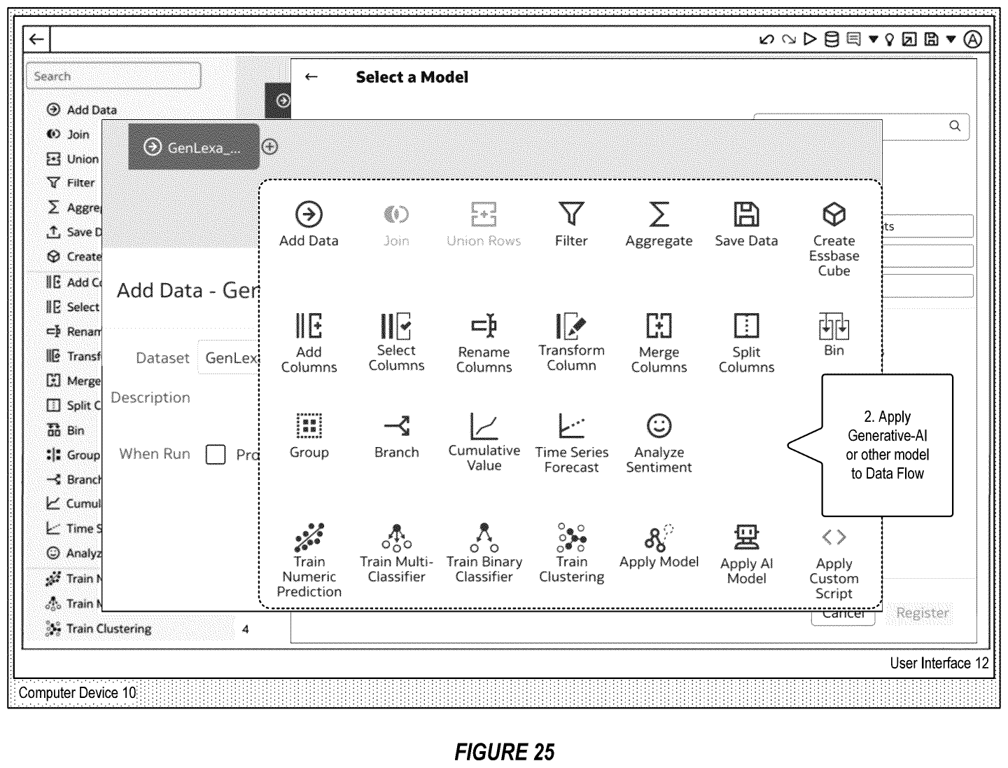

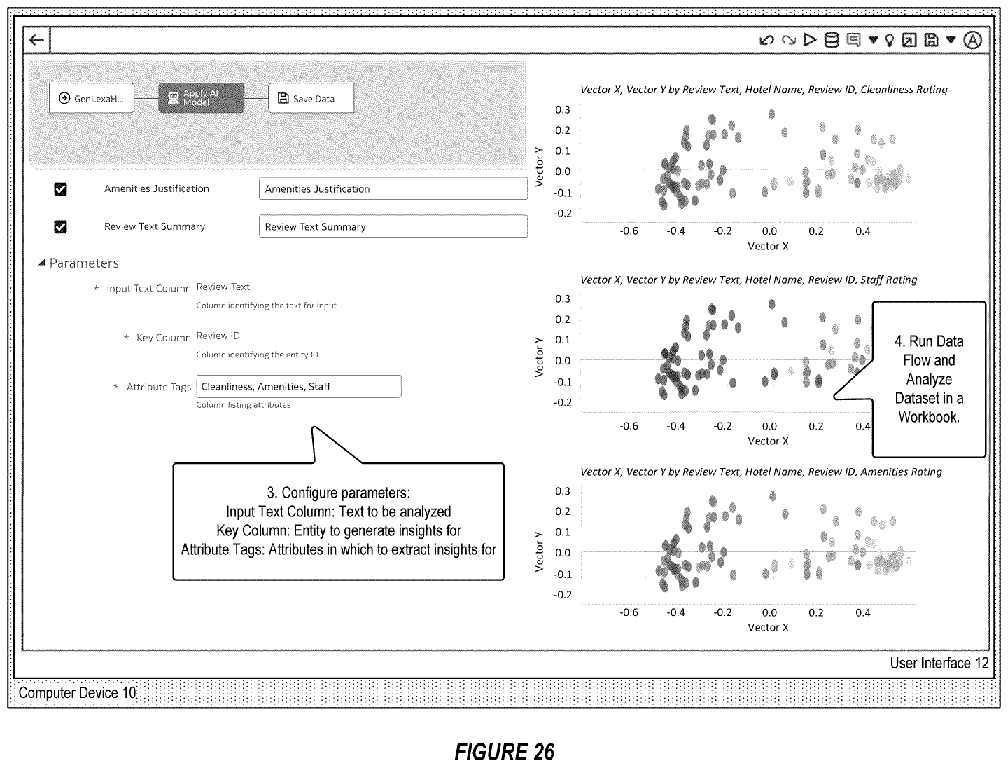

FIGS. 24-26 illustrate an example user interface and interaction with the system, in accordance with an embodiment.

As illustrated in FIGS. 24-26, in accordance with an embodiment, the above-described approach can be used in preparing data analytics, data visualizations, reports, or other types of useful information, for example, to easily spot outliers or explain textual data.

For example, in accordance with an embodiment, the system can be used to: (1) register a generative-AI or other model for use with a dataset; (2) apply the generative-AI or other model to a data flow; (3) configure parameters, including an input text column: text to be analyzed; key column: entity to generate insights for; and attribute tags: attributes in which to extract insights for; and (4) run the data flow and analyze the dataset in a workbook.

### Vector Embedding Model

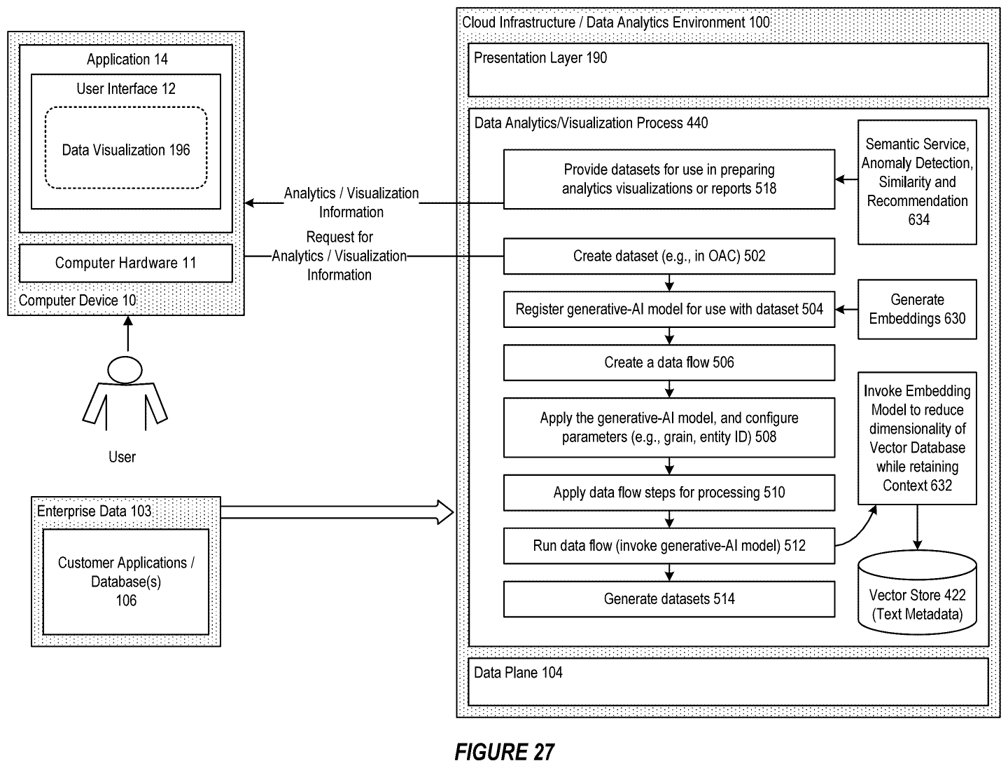

FIG. 27 illustrates an example use of the system in augmenting a vector database, for subsequent use in processing data, in accordance with an embodiment.

As illustrated in FIG. 27, in accordance with an embodiment, the above-described approach can be used, for example, to generate embeddings (630); and invoke an embedding model to reduce dimensionality of the vector database while retaining context (632). The resultant vector database can then be used, for example, to provide a semantic service, anomaly detection, or similarity and recommendation services (634).

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for providing aggregated summaries and aspect scores for unstructured textual data, comprising:
a computer including one or more processors, that provides access to a data analytics environment; and
wherein the system operates to build a summary and numerical rating for each of a plurality of keys associated with the textual data, including:
sending batches of text entries to a large language model to collect intermediate batch results;
using the intermediate batch results to build a numerical score and summary for each key; and
subsequently generating aggregated summaries and aspect scores for the textual dataset, for use in displaying visualizations or returning additional analytical information.

2. The system of claim 1, wherein each of the batches can be processed in parallel, by one or more LLM processor instances, to generate summaries of each batch.

3. The system of claim 1, wherein at least one of:
an initial data flow or dataset may be used to define various aspects reflected within the data that the user is interested in assessing, wherein a user can specify columns of data with user-defined attributes or tags, or
a machine learning process can be used to automatically determine attributes, tags, or aspects that may likely be of interest.

4. The system of claim 1, wherein the LLM prompt can include a prompt or request to the LLM to provide a score value associated with an aspect of interest, and also a confidence level or weighting for that score, wherein when the system subsequently aggregates the scores for summarization purposes, it takes the confidence level or weighting into account; and
wherein the process can then be repeatedly applied on the intermediate results, and similarly in parallel if appropriate, to create summaries of summaries, until the entire amount of unstructured textual data has been processed, and the system can determine an aggregate summary or score.

5. The system of claim 1, wherein the system is provided within a cloud environment and accessed via a cloud service.

6. A method for providing aggregated summaries and aspect scores for unstructured textual data, comprising:
providing, by a computer system including one or more processors, access to a data analytics environment; and
building a summary and numerical rating for each of a plurality of keys associated with the textual data, including:
sending batches of text entries to a large language model to collect intermediate batch results;
using the intermediate batch results to build a numerical score and summary for each key; and
subsequently generating aggregated summaries and aspect scores for the textual dataset, for use in displaying visualizations or returning additional analytical information.

7. The method of claim 6, wherein each of the batches can be processed in parallel, by one or more LLM processor instances, to generate summaries of each batch.

8. The method of claim 6, wherein at least one of:
an initial data flow or dataset may be used to define various aspects reflected within the data that the user is interested in assessing, wherein a user can specify columns of data with user-defined attributes or tags, or
a machine learning process can be used to automatically determine attributes, tags, or aspects that may likely be of interest.

9. The method of claim 6, wherein the LLM prompt can include a prompt or request to the LLM to provide a score value associated with an aspect of interest, and also a confidence level or weighting for that score, wherein when the system subsequently aggregates the scores for summarization purposes, it takes the confidence level or weighting into account; and
wherein the process can then be repeatedly applied on the intermediate results, and similarly in parallel if appropriate, to create summaries of summaries, until the entire amount of unstructured textual data has been processed, and the system can determine an aggregate summary or score.

10. The method of claim 6, wherein the method is provided within a cloud environment and accessed via a cloud service.

11. A non-transitory computer readable storage medium, including instructions stored thereon which when read and executed by one or more computers cause the one or more computers to perform a method comprising:
building a summary and numerical rating for each of a plurality of keys associated with the textual data, including:
sending batches of text entries to a large language model to collect intermediate batch results;
using the intermediate batch results to build a numerical score and summary for each key; and
subsequently generating aggregated summaries and aspect scores for the textual dataset, for use in displaying visualizations or returning additional analytical information.

12. The non-transitory computer readable storage medium of claim 11, wherein each of the batches can be processed in parallel, by one or more LLM processor instances, to generate summaries of each batch.

13. The non-transitory computer readable storage medium of claim 11, wherein at least one of:
an initial data flow or dataset may be used to define various aspects reflected within the data that the user is interested in assessing, wherein a user can specify columns of data with user-defined attributes or tags, or
a machine learning process can be used to automatically determine attributes, tags, or aspects that may likely be of interest.

14. The non-transitory computer readable storage medium of claim 11, wherein the LLM prompt can include a prompt or request to the LLM to provide a score value associated with an aspect of interest, and also a confidence level or weighting for that score, wherein when the system subsequently aggregates the scores for summarization purposes, it takes the confidence level or weighting into account; and
wherein the process can then be repeatedly applied on the intermediate results, and similarly in parallel if appropriate, to create summaries of summaries, until the entire amount of unstructured textual data has been processed, and the system can determine an aggregate summary or score.

15. The non-transitory computer readable storage medium of claim 11, wherein the method is provided within a cloud environment and accessed via a cloud service.
